(19) United States
(12) Patent Application Publication
(10) Pub. No.: US 2011/0228329 A1
(43) Pub. Date: Sep. 22, 2011

(54) IMAGE PROCESSING APPARATUS, AND CONTROL METHOD AND STORAGE MEDIUM THEREFOR

(75) Inventor: Ryousuke Suzuki, Kawasaki-shi (JP)

(73) Assignee: CANON KABUSHIKI KAISHA, Tokyo (JP)

(21) Appl. No.: 13/046,489

(22) Filed: Mar. 11, 2011

(30) Foreign Application Priority Data
Mar. 17, 2010 (JP) 2010-060842

(51) Int. Cl. G06F 3/12

(52) U.S. Cl. 358/1.15

(57) ABSTRACT

An image processing apparatus capable of detecting motions of instruction positions input through a touch panel and performing setting of post processing. The image processing apparatus detects motions of instruction positions input through the touch panel, and performs setting of post processing to be performed by a post-processing apparatus on printed sheets according to the detected motions of the instruction positions.

### BACKGROUND OF THE INVENTION

1. Field of the Invention

The present invention relates to an image processing apparatus and a control method and a storage medium therefor.

2. Description of the Related Art

Some of image processing apparatuses having plural functions or a facsimile function or a printer function is configured to be able to perform a finishing process on printed sheets. The finishing process refers to a process for binding printed sheets (such as stapling and bookbinding) or refers to a process performed on printed sheets (such as hole punching, sheet folding, and adjustment of position of print images on a sheet).

Settings of the finishing process can be performed from a user interface provided by a host computer connected to an image processing apparatus or from a user interface provided by a multi-function peripheral. With regard to finishing process settings, there are techniques for improving user's operability and user-friendliness.

For example, Japanese Laid-open Patent Publication No. 2007-109206 discloses a user interface unit that displays a preview image of a document to be printed by an image forming apparatus on a touch panel and displays setting items (dialogs) for making the settings of a finishing process or the like according to a position on the touch panel touched by a user.

However, since the user is required to perform an operation not intuitively associated with setting contents, it is difficult for the user to learn setting methods to set various finishing processes.

With the setting method using icons or dialogs, the user is required to sequentially give instructions to select a desired setting screen and a desired setting item and to further set an adjustment value, resulting in complicated operations.

With the prior art, settings are made for the entire document, and it is therefore difficult to make settings of each of pages constituting the document.

### SUMMARY OF THE INVENTION

The present invention provides an image processing apparatus and a control method and a storage medium therefor, which are capable of recognizing motions of instruction positions input through a touch panel and performing a setting of post processing.

According to a first aspect of this invention, there is provided an image processing apparatus that causes a post-processing apparatus to perform post processing on a sheet printed with image data, which comprises a detection unit configured to detect motions of instruction positions input through a touch panel, and a setting unit configured to perform setting of the post processing according to the motions of the instruction positions detected by the detection unit.

According to a second aspect of this invention, there is provided a control method for the image processing apparatus described in the first aspect.

According to a third aspect of this invention, there is provided a storage medium storing a program for executing the control method described in the second aspect.

With this invention, it is possible to recognize motions of input instructions input through the touch panel and to perform setting of the post processing.

Further features of the present invention will become apparent from the following description of exemplary embodiments with reference to the attached drawings.

### BRIEF DESCRIPTION OF THE DRAWINGS

FIG. 1 is a block diagram showing the construction of an image processing system including an image processing apparatus according to a first embodiment of this invention;

FIG. 2A is a flowchart showing procedures of data processing performed by a host computer of the image processing system;

FIG. 2B is a flowchart showing procedures of data processing performed by the image processing apparatus;

FIG. 3 is a view showing a UI screen displayed on a display device of the host computer;

FIG. 4A is a view showing an example of a bookbound print product output from a post-processing apparatus of the image processing system;

FIG. 4B to FIG. 4E are views showing binding directions that can be set by the host computer;

FIGS. 4F and 4G are views showing sheet discharging methods that can be set by the host computer;

FIG. 4H is a view showing types of folding that can be set by the host computer;

FIG. 5 is a view showing an example print job transmitted from the host computer to the image processing apparatus;

FIG. 6A is a view showing an example user interface screen for document data selection, which is displayed on a display unit of the image processing apparatus;

FIG. 6B is a view showing an example user interface displayed on the display unit;

FIG. 7 is a flowchart showing procedures of a process performed by a second print setting unit of the image processing apparatus based on a print job received in the data processing shown in FIG. 2B;

FIG. 8 is a view showing an example structure of a print setting condition;

FIG. 9 is a view showing regions on an output sheet that can be set by the image processing apparatus;

FIG. 10A is a view showing definitions of various nodes that constitute a sub input procedure tree defined by the second print setting unit;

FIG. 10B is a view showing an example sub input procedure tree defined by the second print setting unit;

FIGS. 11A and 11B are views each showing an example print setting operation screen displayed on the display unit;

FIGS. 12A to 12C are views showing sub input procedure trees defined by the second print setting unit;

FIGS. 13A to 13C are views showing types of punch holes that can be set by the second print setting unit;

FIG. 13D is a view showing an image displayed in an image data display region shown in FIG. 11A after a printing position is changed;

FIG. 13E is a view showing an input procedure tree obtained by combining sub input procedure trees;

FIG. 14A is a view showing an example of a print setting edit screen;

FIG. 14B is a sub input procedure tree corresponding to a screen display shown in FIG. 14A;

FIG. 14C is a view showing a print setting edit screen similar to that shown in FIG. 14A;

FIG. 14D is a sub input procedure tree similar to that shown in FIG. 14B;

FIGS. 15B and 15B are views each showing an example print setting operation screen;

FIGS. 16A to 16C are views showing sub input procedure trees respectively corresponding to feature regions displayed on the screen shown in FIG. 15B;

FIGS. 17A and 17B are views each showing an example print setting operation screen;

FIGS. 18A to 18C are views showing sub input procedure trees respectively corresponding to feature regions displayed on the screen shown in FIG. 17B;

FIGS. 19A to 19E are views showing an example of print setting operations; and

FIG. 20 is a view showing a print setting operation screen in a third embodiment of this invention.

### DESCRIPTION OF THE EMBODIMENTS

The present invention will now be described in detail below with reference to the drawings showing preferred embodiments thereof.

### First Embodiment

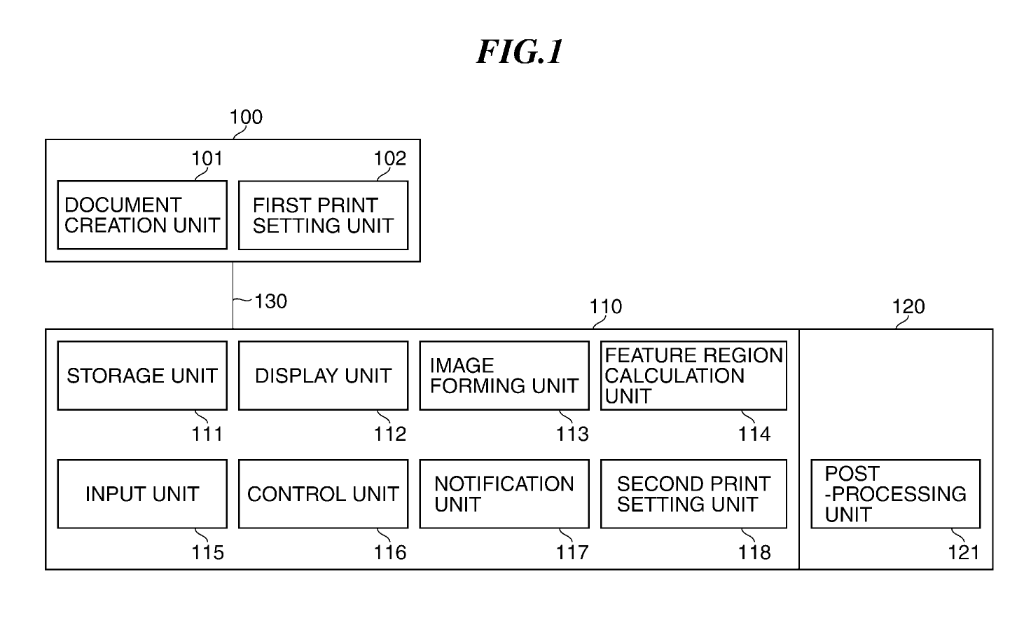

FIG. 1 shows in block diagram the construction of an image processing system including an image processing apparatus according to a first embodiment of this invention. In the example shown in FIG. 1, an image processing apparatus 110 is connected with a host computer 100 via a network 130 and connected with a post-processing apparatus 120. The image processing apparatus 110 is configured to communicate with the host computer 100 to receive a job, process the received job, and cause the post-processing apparatus 120 to perform prost-processing, where required. The image processing apparatus 110 is implemented by, e.g., a multifunction peripheral (MFP), but this is not limitative. The image processing apparatus 110 can be implemented by a print system or the like.

In the host computer 100, reference numeral 101 denotes a document creation unit that executes an application installed on the host computer 100 to create a document. It should be noted that an illustration of hardware resources (such as a CPU, ROM, and RAM) of the host computer 100 is omitted.

Reference numeral 102 denotes a first print setting unit that creates a print job for a document created by the document creation unit 101 according to a print condition, which is input via a print setting screen provided by a so-called printer driver.

The first print setting unit 102 converts the document created by the document creation unit 101 into document data that can be interpreted by the image processing apparatus 110, and adds print settings to the document data. The print settings include settings of post processing such as a binding process, a stapling process, and a sorting process that can be performed by the post-processing apparatus 120.

The document creation unit 101 is implemented by, e.g., a word processing application running on the host computer 100.

In the image processing apparatus 110, reference numeral 111 denotes a storage unit that stores the print job, which includes the print settings and which has been created by and transmitted via the network 130 from the host computer 100. The image processing apparatus 110 includes a display unit 112 that has a touch panel on which is displayed a user interface screen for setting the print settings that include the settings of the post-processing apparatus 120.

The image processing apparatus 110 also includes an image forming unit 113 for forming image data based on the document data including the print settings and stored in the storage unit 111.

The image processing apparatus 110 includes a feature region calculation unit 114 that calculates one or more feature regions of the image data based on the document data stored in the storage unit 111 and including the print settings and based on the image data formed by the image forming unit 113.

The image processing apparatus 110 includes an input unit 115 for inputting position information (coordinate value) that represents a position on the display unit 112. The input unit 115 is implemented by, e.g., the touch panel of the display unit 112.

The image processing apparatus 110 includes a control unit 116 that restricts, according to a state of the image processing apparatus 110, user's operations to edit the print settings stored in the storage unit 111. The control unit 116 overall controls the image processing apparatus 110 and the post-processing apparatus 120. The control unit 116 includes hardware resources such as a CPU, ROM, and RAM (none of which are shown). The CPU of the control unit 116 reads programs stored in the ROM to execute the programs to perform various control.

The image processing apparatus 110 also includes a notification unit 117 that notifies the user of information about candidate input operation methods acceptable by the input unit 115 under the restriction given by the control unit 116.

The image processing apparatus 110 further includes a second print setting unit 118 for editing the print settings stored in the storage unit 111 according to input entered through the input unit 115.

The post-processing apparatus 120 is detachably mounted to the image processing apparatus 110, and includes one or more post-processing units (hereinafter, referred to as the post-processing unit 121) that perform post processing on a sheet printed by the image processing apparatus 110. When the post-processing apparatus 120 is mounted to the image processing apparatus 110, the control unit 116 of the image processing apparatus 110 is able to acquire ability information of the post-processing apparatus 120 from a ROM (not shown) of the apparatus 120, thereby identifying types of post processing that can be performed by the post-processing apparatus 120.

As types of post processing performed by the post-processing unit 121, there can be mentioned, for example, stapling processing, punching processing, folding processing, and bookbinding processing. These processing can be performed by different post-processing units of the post-processing apparatus or by a single post-processing unit thereof.

The image processing apparatus 110 acquires the ability information of the post-processing apparatus 120 (such as stapling position, number of punch holes, type of folding processing) from the apparatus 120, and indicates post processing candidates to the user. The user selects the desired post processing from the indicated candidates.

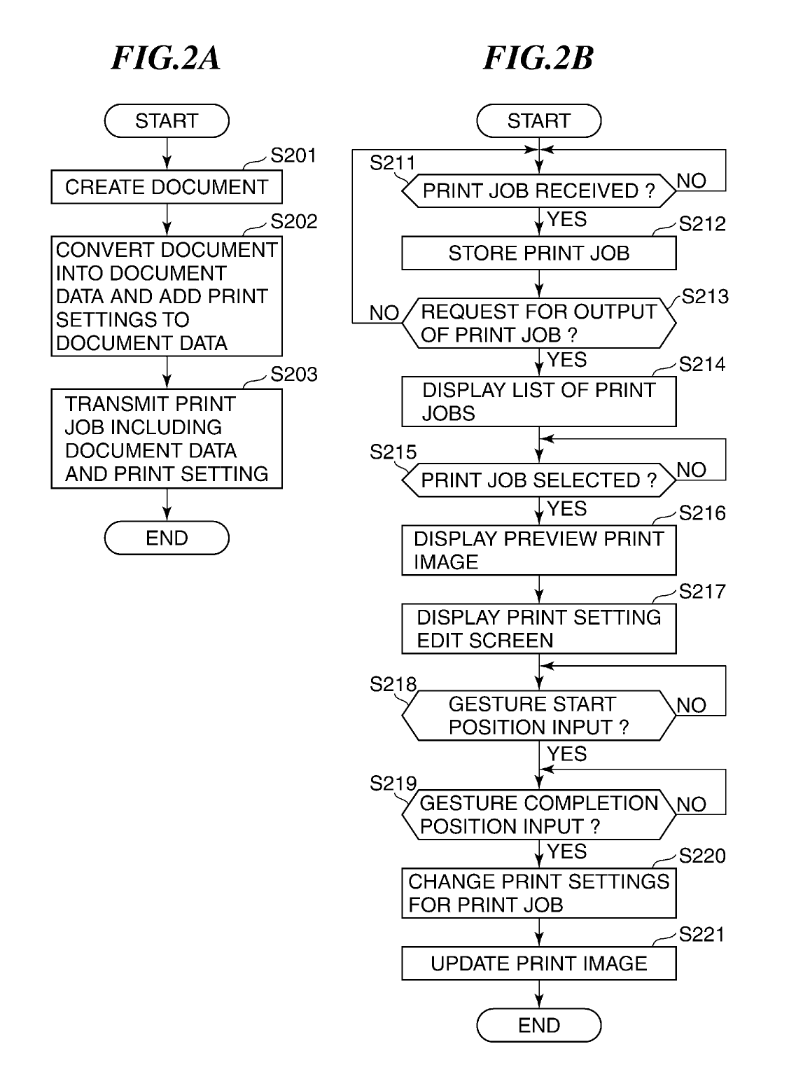

FIGS. 2A and 2B show in flowchart procedures of data processing respectively performed by the host computer 100 and the image processing apparatus 110. These data processing are respectively performed by the CPU of the host computer 100 and the CPU of the image processing apparatus 110 by executing programs stored in the storage units.

On the side of the host computer 100, the document creation unit 101 executes an application and creates a document according to a user's input (S201). Next, according to a request from the document creation unit 101, the first print setting unit 102 converts the created document into document data (print data) and adds print settings to the document data (S202).

Then, the host computer 100 transmits, as a print job, the created document data including the print settings to the image processing apparatus 110 via the network 130 (S203), and completes the present process.

On the side of the image processing apparatus 110, the control unit 116 waits for reception of the print job by the input unit 115 from the host computer 100 (S211). Next, the control unit 116 adds identification information to the received print job and stores it into a BOX region of the storage unit 111 (S212).

Then, the control unit 116 determines whether a request for output of print job is input (S213). A request for output of print job is input by the user through the touch panel (input unit 115) of the image processing apparatus 110.

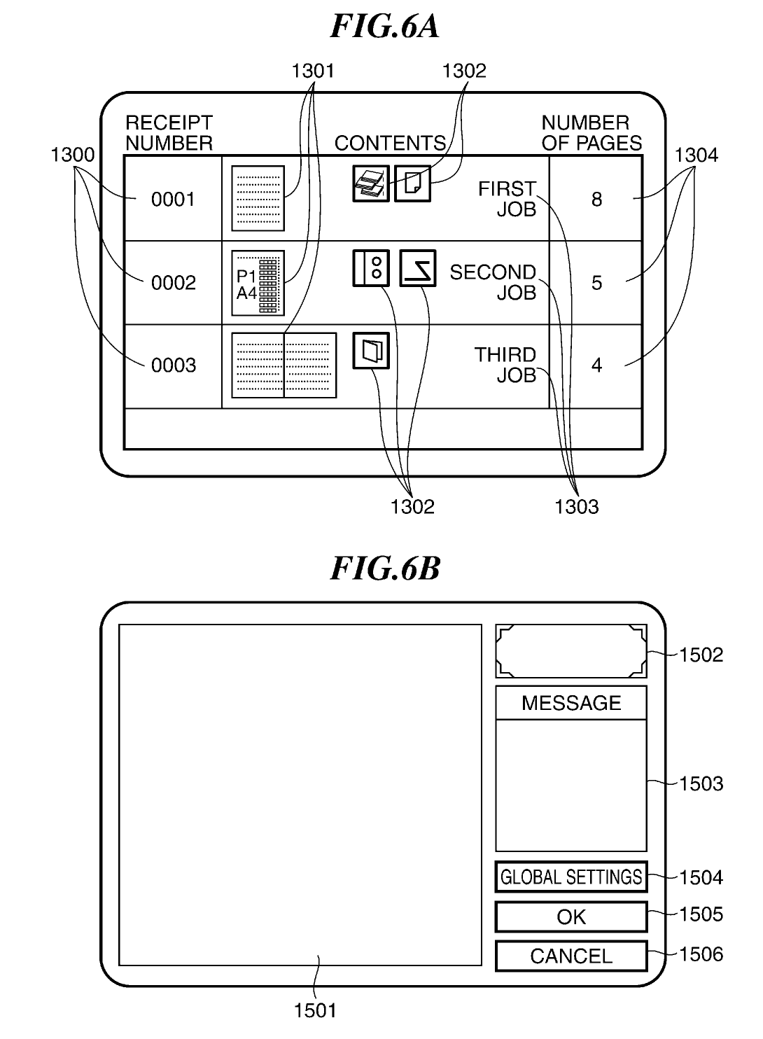

If it is determined in S213 that a request for output of print job is input, the flow proceeds to S214 where the control unit 116 causes the display unit 112 to display a list of print jobs stored in the storage unit 111, as shown by way of example in FIG. 6A. From among the print jobs displayed in the list, the user is able to select a print job to be output.

If it is determined in S215 that a print job is selected, the flow proceeds to S216 where the control unit 116 creates sub-procedure trees (such as those described later) according to the print settings contained in the selected print job. Then, the control unit 116 cooperates with the second print setting unit 118 to cause the display unit 112 to display a preview print image in, e.g., a region 1501 shown in FIG. 6B. At that time, contents of the print settings are displayed so as to be associated with the preview print image. In a case, for example, that the settings are made to perform punching on a sheet, punch holes are displayed in association with the preview print image. The details thereof will be described later.

Next, according to an input procedure tree, which is created by procedures (described later), the control unit 116 cooperates with the second print setting unit 118 to cause the display unit 112 to display a print setting edit screen, e.g., a screen 2010 shown in FIG. 11B (S217).

In a region 1503 of the screen 2010, a message is displayed that indicates names of feature regions. In this embodiment, as the names of feature regions, punch hole, binding position, and page are displayed as shown in FIG. 11B. These feature regions are made corresponding to the print settings for the print job and used to edit the print settings.

The user is able to change (move) feature regions, i.e., post processing locations (positions where post processing is performed) displayed on the screen 2010 or to increase or decrease the number of post processing locations by performing a gesture operation with a finger, pen or the like on the touch panel. To this end, the user inputs with a finger or the like a gesture start position for a post processing location through the touch panel.

The control unit 116 determines whether a gesture start position for a post processing location is input (S218). If a gesture start position is input, the control unit 116 determines whether a gesture completion position for the post processing location is input (S219). The user is able to input a gesture completion position by moving and pressing a finger or the like on the touch panel and then getting the finger or the like away from the touch panel.

If a gesture completion position is input, the control unit 116 acquires the ability information of the post-processing apparatus 120 from the apparatus 120. Based on the acquired ability information and the gesture operation performed by the user, the control unit 116 changes the print settings for a page of the print job corresponding to the currently displayed preview print image, e.g., moves the post processing location (S220).

Next, according to the changed print settings, the control unit 116 updates a preview print image displayed on the display unit 112 (S221), and completes the present process. In the updated preview print image, the feature region specified by the user's gesture operation is displayed, while being moved from the gesture operation start position to the gesture operation completion position. The gesture operation refers to a user's finger operation to input an instruction position.

The process shown in FIG. 2B is performed for each page of the print job. In other words, the processing in S216 to S221 is repeated for all the pages of the print job.

The edited print settings are stored into the storage unit 111.

As described above, according to a user's instruction entered through the touch panel, any of feature regions relating to the print settings for a print job (e.g., a feature region corresponding to a punch hole) can be changed on a preview print image showing a finished product. To accept a gesture operation for each of feature regions in the print settings displayed on the display unit 112, the second print setting unit 118 creates sub input procedure trees (described later) for the print settings on a per page basis. As a result, the user is able to directly handle, on the touch panel, the feature regions displayed on the display unit 112. The second print setting unit 118 performs control to reflect a user's gesture operation entered through the touch panel to the print settings for the print job and to the preview print image.

It is therefore possible for the user to intuitively perform an operation to specify a part of the print settings to be changed and intuitively perform an operation to move such part or increase or decrease the number of such parts on the touch panel. In the case, for example, of changing positions of punch holes, the user is able to input a gesture operation to simultaneously specify and move two punch holes and able to give an instruction to change the print settings, while confirming the finished product through the preview print image.

It should be noted that the details of operation of the second print setting unit 118 will be described later.

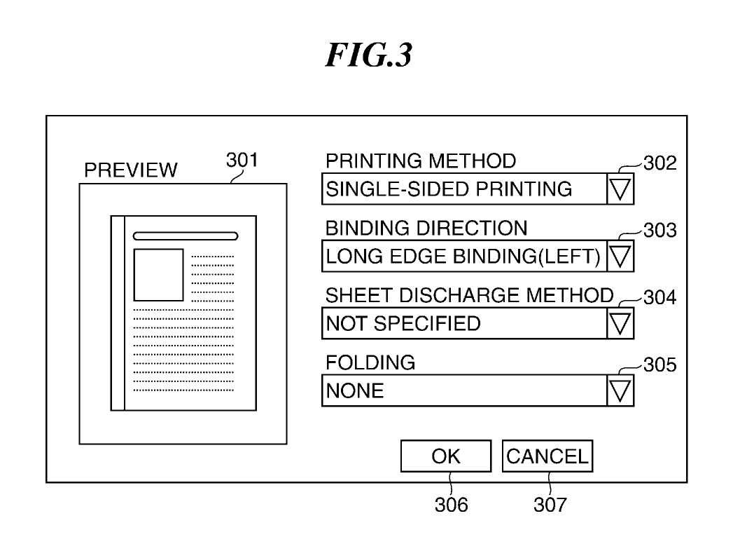

FIG. 3 shows a user interface (UI) screen displayed on a display device of the host computer 100. In this example, the UI screen is provided by the first print setting unit 102 of the host computer 100.

When printing is selected by the user from the application, the first print setting unit 102 causes the display device of the host computer 100 to display the UI screen shown in FIG. 3, which is used by the user to set print settings (including post processing settings) for created document data.

In FIG. 3, reference numeral 301 denotes a preview region in which there is displayed a preview image that schematically shows a product obtainable according to the print settings. Reference numerals 302 to 305 denote dropdown list boxes for respectively specifying a printing method, binding direction, sheet discharge method, and folding method.

Reference numeral 306 denotes an OK button pressed to confirm the print settings set based on information input through the UI screen and to start a process for transmitting the print settings and document data to the image processing apparatus 110. Reference numeral 307 denotes a cancel button pressed to discard information input through the UI screen.

In this embodiment, single-sided printing, double-sided printing, and booklet printing are displayed in the dropdown list box 302, as printing methods that can be set by the first print setting unit 102.

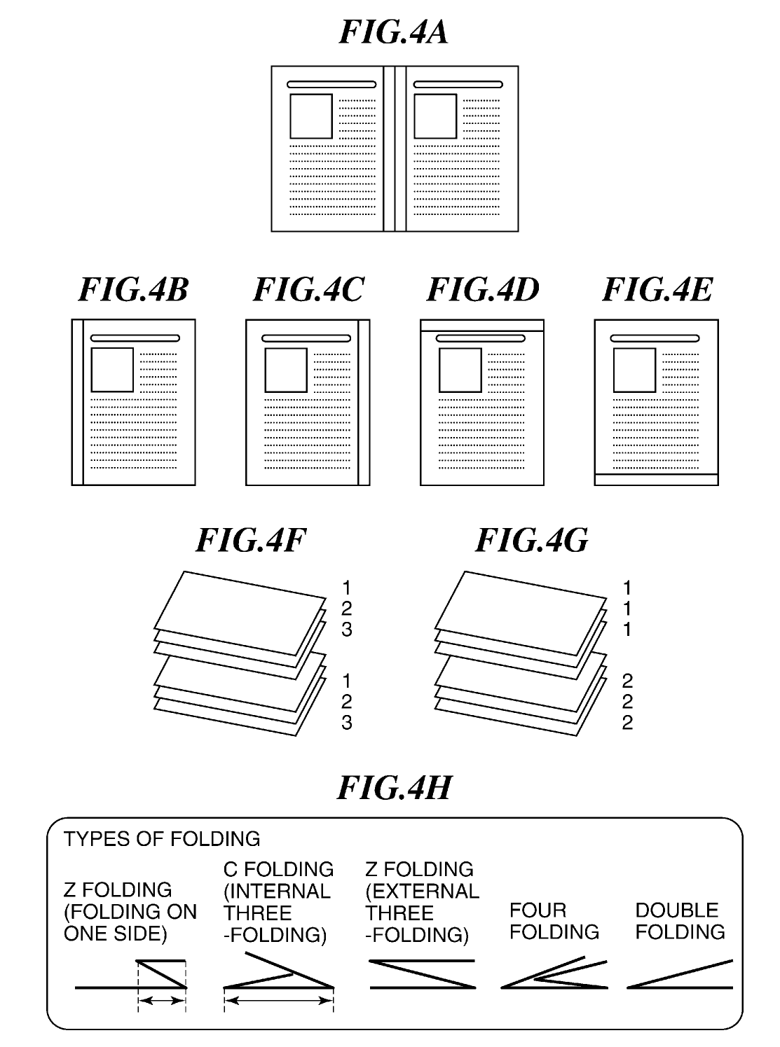

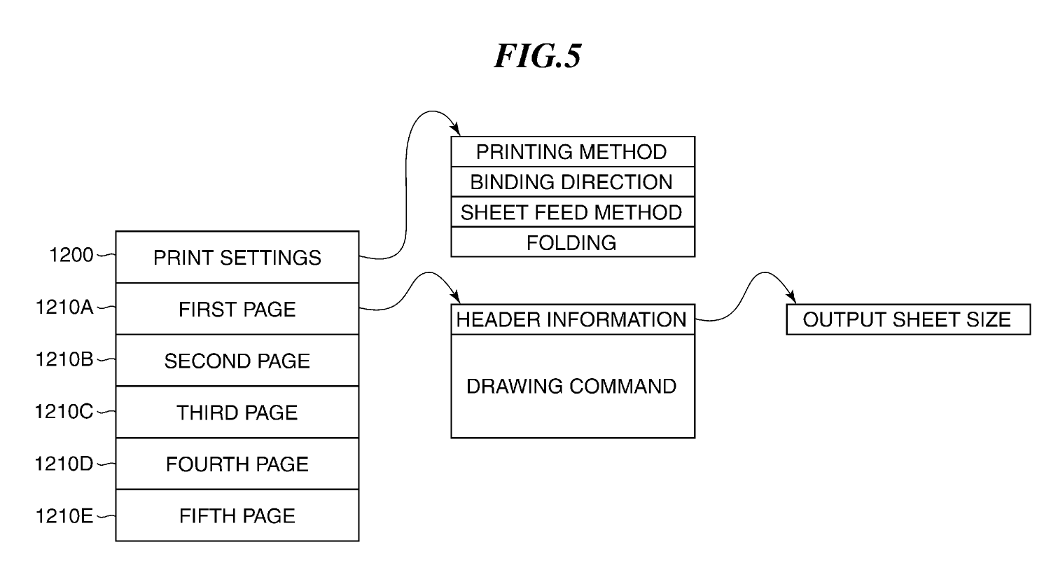

The single-sided printing refers to printing to print-out each page of document data only on one surface of an output sheet, the double-sided printing refers to printing to print-out each two pages of document data on both surfaces of an output sheet, and the booklet printing refers to saddle-stitching bookbinding printing to print-output each two continuous pages of document data on a double-spread page (see FIG. 4A).

As binding directions that can be set by the first print setting unit 102, long edge binding (left), long edge binding (right), short edge binding (upper), and short edge binding (lower), which are respectively shown in FIGS. 4B to 4E, are displayed in the dropdown list box 303.

As sheet discharging methods that can be set by the first print setting unit 102, sorting, grouping, punching, and stapling are displayed in the dropdown list box 304.

In a case that plural sets of document data are printed, a sheet discharging method is selected to specify the order in which pages of document data are printed. In this embodiment, either sorting or grouping can be selected as the sheet discharging method, as shown in FIGS. 4F and 4G.

The punching refers to a process for punching holes in a sheet, and the stapling refers to a process for stapling sheets. Positions where punch holes are to be formed and a position where stapling is to be performed are determined based on the binding direction specified in the list box 303.

As types of folding that can be set by the first print setting unit 102, non-folding, Z folding (folding on one side), C folding (internal three-folding), Z folding (external three-folding), four folding, and double folding, which are shown in FIG. 4H, are displayed in the dropdown list box 305.

In this embodiment, it is assumed that each type of folding set by the first setting unit 102 is only applied to a document data page that is print-output to an output sheet of a particular size. For example, it is assumed that Z folding (folding on one side) is only applied to a page print-output to an output sheet of A3 size. Depending on the post-processing apparatus 120 connected to the image processing apparatus 110, a distance between folding positions in the Z folding (folding on one side), shown by arrow in FIG. 4H, can be adjusted in a range, e.g., from 70 mm to 108 mm and a distance between folding positions in the C folding, shown by another arrow in FIG. 4H, can also be adjusted in a range, e.g., from 100 mm to 120 mm. In that case, by performing the data processing shown in FIG. 2B, the control unit 116 is able to change the folding positions set in the print job to those instructed by the user through the touch panel. The details of how the folding positions are changed will be described later.

FIG. 5 shows an example print job including document data and print settings and transmitted from the host computer 100 to the image processing apparatus 110. The print job received by the apparatus 110 is stored into the storage unit 111.

In FIG. 5, reference numeral 1200 denotes the print settings set on the UI screen shown in FIGS. 3, and 1210A to 1210E respectively denote page data corresponding to pages (first to fifth pages in this example) of a document created by the document creation unit 101. The print settings include setting information about printing method (such as print layout and print density), binding direction, sheet feed method, and folding method.

As shown in FIG. 5, each page data includes header information and a drawing command for reproducing page contents as image data. The header information includes output sheet size information for the page. The print job described above is transmitted from the host computer 100 to the image processing apparatus 110 and stored into the storage unit 111 of the apparatus 110.

FIG. 6A shows an example user interface screen displayed on the display unit 112 of the image processing apparatus 110 and used to select, from among plural pieces of document data stored in the storage unit 111, document data including print settings to be edited.

In FIG. 6A, reference numeral 1300 denotes receipt numbers each assigned to document data including print settings when the document data was stored into the storage unit 111.

Reference numeral 1301 denotes images (thumbnails) of top pages of respective document data stored in the storage unit 111, which are displayed on the screen in reduced size.

Reference numeral 1302 denotes icons that represent the print settings for respective documents, 1303 denotes names of respective document data stored in the storage unit 111, and 1304 denotes the total page numbers of the respective document data including print settings.

The image processing apparatus 110 selects, from among document data displayed on the screen shown in FIG. 6A, document data corresponding to a coordinate input through the input unit 115, and notifies the selected document data including print settings to the second print setting unit 118.

Each of the names 1303 of respective document data displayed on the screen shown in FIG. 6A can be created by the first print setting unit 102 and then stored into the print settings 1200 of each document data (shown in FIG. 5), or can automatically be assigned by the image processing apparatus 110 when the document data including print settings is stored into the storage unit 111. It is also possible that the names 1303 can be edited by the input unit 115.

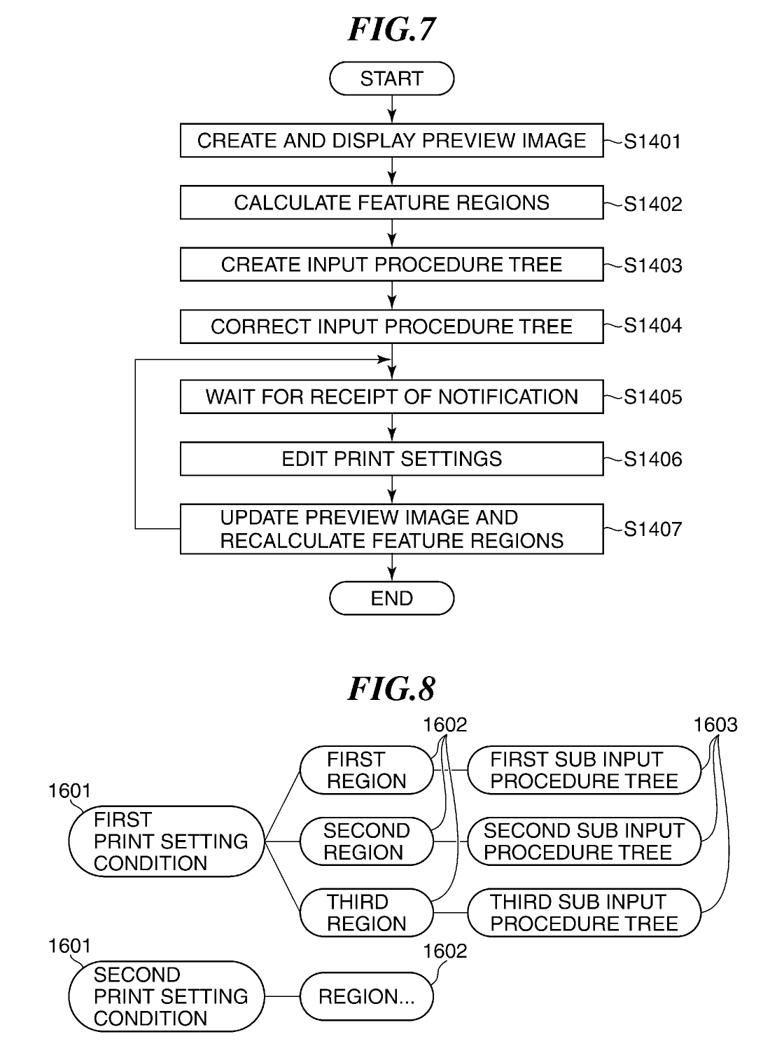

FIG. 7 shows in flowchart procedures of a process executed by the second print setting unit 118 (CPU) of the image processing apparatus 110.

The image forming unit 113 of the image processing apparatus 110 creates image data of all the pages of document data contained in the print job received in S211 in the data processing shown in FIG. 2B, and notifies the created image data to the second print setting unit 118. In response to this, the second print setting unit 118 causes the display unit 112 to display a preview image corresponding to part or all of the image data (S1401).

Next, based on the print settings for the print job obtained in the data processing shown in FIG. 2B, the second print setting unit 118 calculates feature regions to be displayed on the display unit 112 (S1402). The details of the feature regions will be described later.

Next, based on the print settings set in the print job, the second print setting unit 118 creates an input procedure tree by combining sub input procedure trees (S1403). The sub input procedure trees are each defined on a per print setting basis and show to the user the input procedures of an operation to edit the print settings.

The input procedure tree refers to pieces of information that define operation methods and edit methods, which are to be performed by the user to edit the print settings for the document data displayed on the display unit 112. The details of the input procedure tree will be described later.

Next, the setting unit 118 cooperates with the control unit 116 to determine whether respective edit methods defined in the input procedure tree created in S1403 can be executed by the image processing apparatus 110, and deletes one or more unexecutable edit methods, if any, from the input procedure tree, thereby correcting the input procedure tree (S1404).

The input unit 115 accepts an action given by a user's gesture operation, and notifies coordinate information about the input action and information about an instructed feature region to the second print setting unit 118. The setting unit 118 waits for receipt of a notification from the input unit 115 (S1405).

When receiving the notification, the second print setting unit 118 processes the coordinate information input from the input unit 115 according to the input procedure tree, thereby editing the print settings (S1406).

Based on a result of editing the print settings in S1406, the second print setting unit 118 updates information about the preview image to be displayed on the display unit 112 and again calculates the feature regions (S1407). Each time input of action is notified, the second print setting unit 118 repeats the processing in S1405 to S1407. In this example, the displaying of the preview image on the display unit 112, the updating of information of preview image, etc. are performed by the cooperation of the control unit 116 and the second print setting unit 118, but can be performed by either the control unit 116 or the second print setting unit 118.

FIG. 6B shows a UI screen displayed on the display unit 112 by the second print setting unit 118. In FIG. 6B, reference numeral 1501 denotes a region where a preview image is displayed based on the image data created by the image forming unit 113 of the image processing apparatus 110 in S1401 of FIGS. 7, and 1502 denotes a region where information about the image data corresponding to the preview image displayed in the region 1501 is displayed.

Reference numeral 1503 denotes a region where there is displayed information about operations that can be input by the user through the touch panel according to the input procedure tree corrected in S1407 of FIGS. 7, and 1504 denotes a button for causing the image processing apparatus 110 to again set print settings equivalent to the print settings set by the first print setting unit 102 of the host computer 100.

Reference numeral 1505 denotes a button for notifying completion of operations of the second print setting unit 118, and 1506 denotes a button for cancelling operations performed by the second print setting unit 118.

If a coordinate position notified from the input unit 115 corresponds to a coordinate position of the button 1505, the second print setting unit 118 determines that an instruction to complete the editing is given. If a coordinate position notified from the input unit 115 corresponds to a coordinate position of the button 1504, the second print setting unit 118 causes a UI screen similar to that shown in FIG. 3 to be displayed, thereby enabling the user to edit the print settings for document data on the screen.

In this embodiment, the second print setting unit 118 defines one or more regions on an output sheet (hereinafter sometimes referred to as the output sheet region(s)) on a per print setting condition basis, and defines sub input procedure trees on a per output sheet region basis.

The print setting condition refers to a condition that can arbitrarily be defined in the print settings 1200 shown in FIG. 5, such as forming punch holes, performing Z folding (folding on one side), and so on.

FIG. 8 shows an example print setting condition.

In the example shown in FIG. 8, reference numeral 1601 denotes the print setting condition in which first and second print setting conditions are defined. Reference numeral 1602 denotes pieces of information about first to third output sheet regions and another output sheet region each defined on a per print setting condition basis, and reference numeral 1603 denotes first to third sub input procedure trees.

In the following, a description will be given of a feature region. The feature region refers to a region that corresponds to an output sheet region for which print settings coincident with the print setting condition are set. More specifically, the feature region corresponds to, e.g., a region of image data (preview print image) displayed in the region 1501 shown in FIG. 6B.

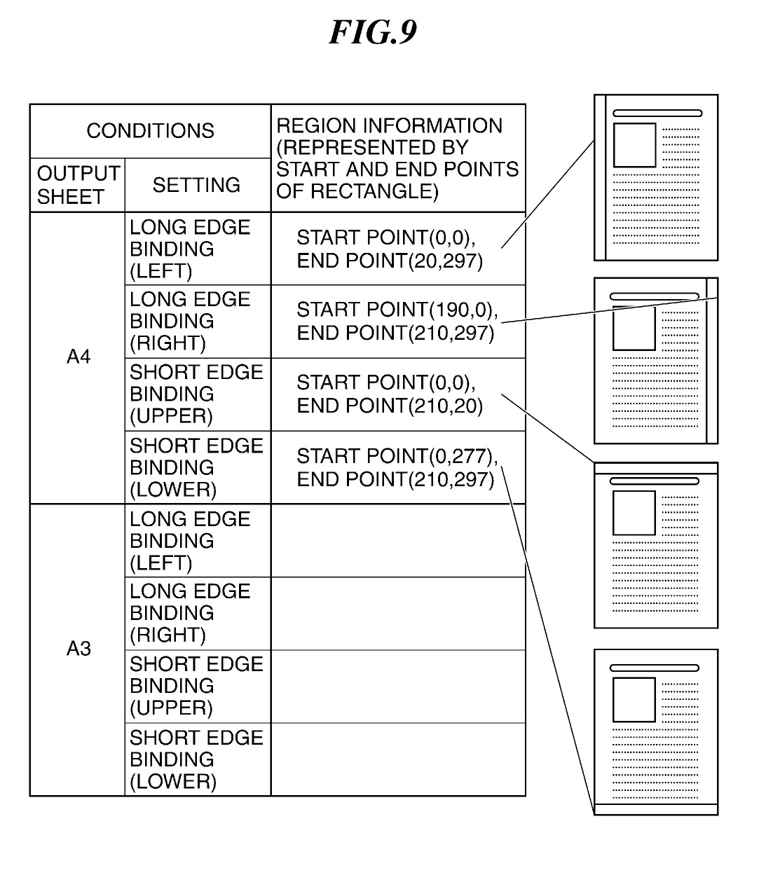

The image data is displayed in the region 1501 in FIG. 6B in various forms according to screen operations. On the other hand, output sheet regions (see FIG. 9) each defined on a per print setting condition basis remain unchanged, irrespective of screen operations.

The output sheet regions can each be further conditioned in terms of print setting condition and output sheet condition. In a case, for example, that the print setting condition includes a binding setting which specifies that stapling or punching should not be made, the output sheet regions can be defined on a per binding position condition basis and on a per output sheet condition basis.

The sub input procedure tree refers to tree structure information that defines an operation that can subsequently be input by the user by means of a gesture and that defines a resultant action performed based on the user's operation in a case where the second print setting unit 118 receives for the first time a coordinate corresponding to a feature region. In the below described drawings each showing a sub input procedure tree, a block named “action” is a block for processing a user's instruction entered through the display unit 112 by means of a gesture operation and for reflecting the processed instruction to preview processing.

A further description will be given of sub input procedure trees.

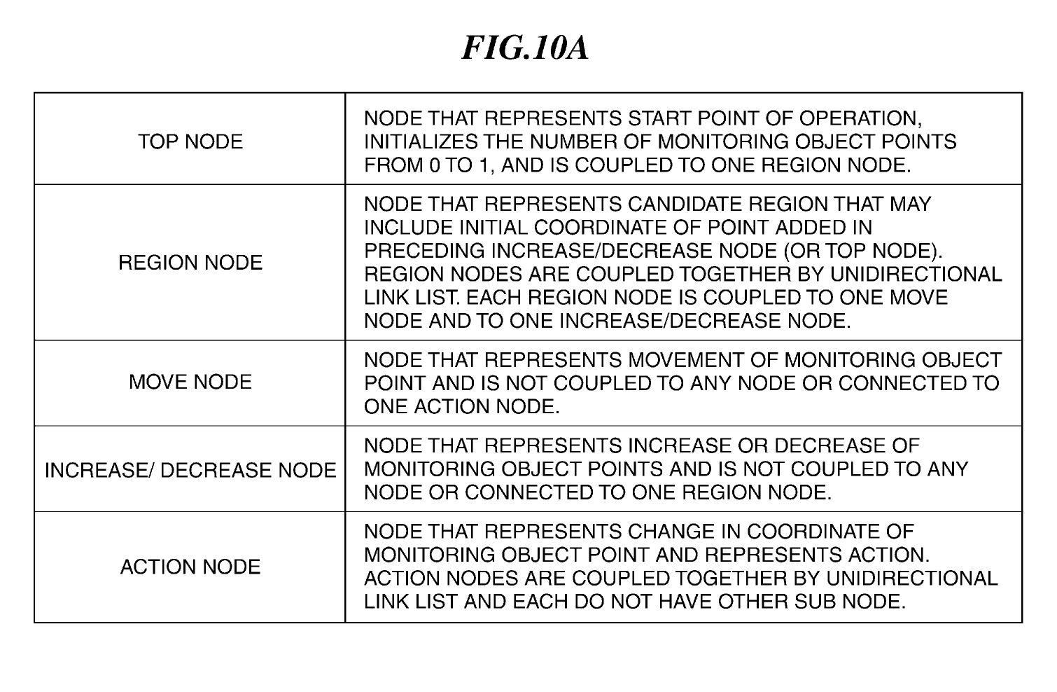

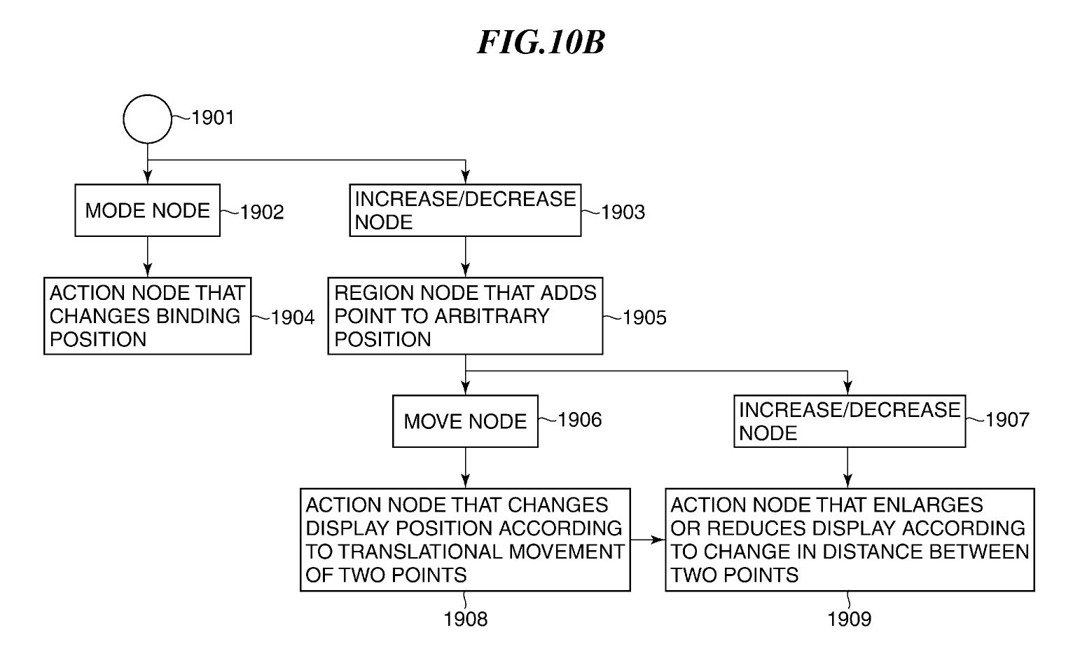

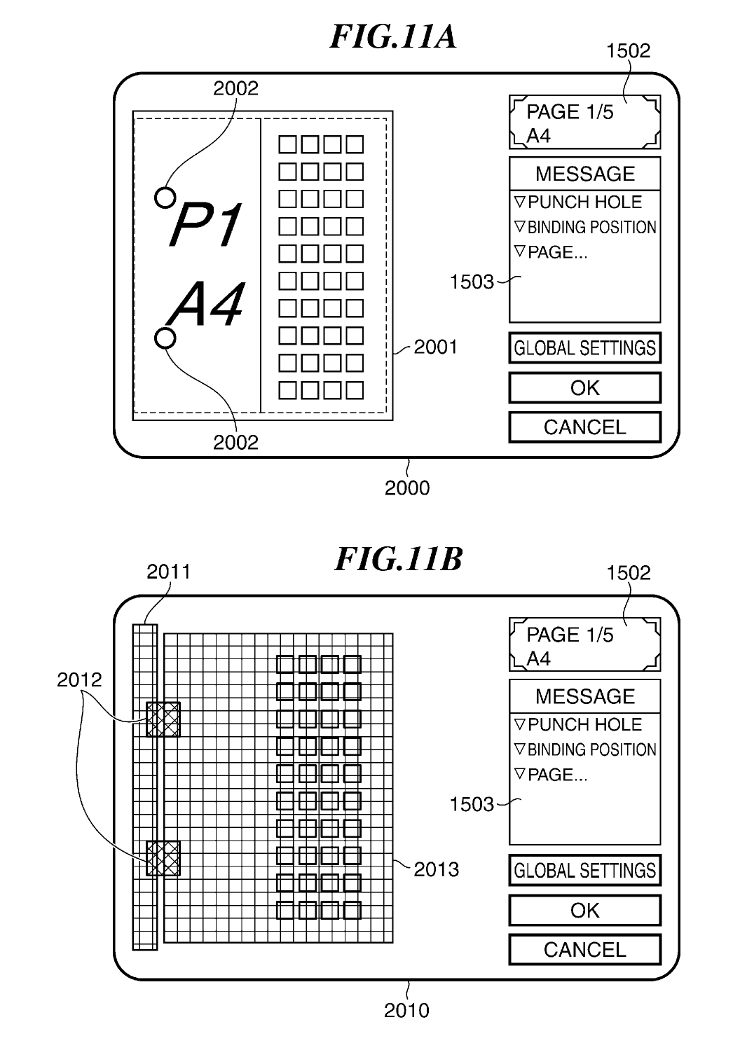

FIG. 10A shows definitions of various nodes that constitute a sub input procedure tree defined by the second print setting unit 118 of the image processing apparatus 110, and FIG. 10B shows an example sub input procedure tree.

As shown in FIG. 10A, a sub input procedure tree is constituted by a plurality of nodes such as a top node, region node, move node, increase/decrease node, and action node. The move node is a node entered when a sliding motion of one or more fingers is detected, with the number of fingers detected by the touch panel kept unchanged. The increase/decrease node is a node entered when it is detected that the number of fingers detected by the touch panel increases or decreases.

In the definitions of the nodes in FIG. 10A, the monitoring object point refers to a coordinate group which is spatially continuous and notified from the input unit 115. In a case that the input unit 115 is formed by a touch panel, a position where the touch panel is pressed by the user with finger is detected as the monitoring object point from when the touch panel is started to be pressed by the finger to when the finger is detached from the panel.

The monitoring object point can be plural in number. Specifically, in a case that the input unit 115 formed by a touch panel is touched by the user with fingers, respective touched positions are detected as monitoring object points (instruction positions).

An operation not defined in the sub input procedure tree is regarded as an invalid operation, so that the second print setting unit 118 does not change the print settings and the display method.

FIG. 10B shows an example sub input procedure tree for a region where no binding processing (punching, stapling) is performed at a binding position.

In FIG. 10B, reference numeral 1901 denotes a top node, 1902 denotes a move node coupled to the top node 1901, 1903 denotes an increase/decrease node coupled to the top node 1901, and 1904 denotes an action node coupled to the move node 1902. The action node 1904 represents that a binding position should be changed according to a movement (motion) of the monitoring object point concerned. For example, the second print setting unit 118 defines, as a new binding position, a position in the image data (preview image) displayed in the region 150 in FIG. 6B and closest to a position where the user's finger is detached from the touch panel, thereby changing the binding position.

Reference numeral 1905 denotes a region node coupled to the increase/decrease node 1903. The region node 1905 represents that a monitoring object point should be added to an arbitrary position. The addition of the monitoring object point makes the number of monitoring object points equal to two. Reference numeral 1906 denotes a move node coupled to the region node 1905, and 1907 denotes an increase/decrease node coupled to the region node 1905.

Reference numeral 1908 denotes an action node coupled to the move node 1906. In a case where the two monitoring object points are translationally moved, with a distance therebetween kept unchanged, the action node 1908 represents that positions of relevant parts in the image data displayed in the region 1501 in FIG. 6B should be moved according to movements of the monitoring object points. An operation to move the moving object points is achieved by a gesture operation for giving an instruction to move feature regions (including post processing locations) displayed on the display unit 112.

The action node 1908 is coupled to another action node 1909. The action node 1909 represents that the size of the image data displayed in the region 1501 in FIG. 6B is enlarged or reduced according to a change in distance between the two monitoring object points, if these points move such that the distance therebetween changes (for example, if an operation is performed such that fingers in contact with the touch panel are moved toward and away from each other).

An input procedure tree is created by the second print setting unit 118 by combining a plurality of sub input procedure trees together. Specifically, the second print setting unit 118 regards the top node of a sub input procedure tree as a region node and couples it to the top node of the input procedure tree. Further, the second print setting unit 118 converts a coordinate representing a region of each region node into a coordinate in a coordinate system defined for the region 1501 in FIG. 6B.

In the following, concrete examples of actions of the second print setting unit 118 will be individually described for different print setting conditions.

First, a description will be given of an example action of the second print setting unit 118 in a case that the print setting condition specifies that punch holes should be formed.

FIGS. 11A and 11B each show an example print setting operation screen displayed on the display unit 112 of the image processing apparatus 110. In these examples, the second print setting unit 118 causes the display unit 112 to display a screen 2000 or 2010.

In the screen 2000 in FIG. 11A, reference numeral 2001 denotes an image data display region in which image data corresponding to any of pages of a received print job is displayed, and 2002 denotes punch holes specified in the print settings for the print job set by the first print setting unit 102 of the host computer 100. When the print job is selected by the user, a print image showing a finished product to which the print settings set by the first print setting unit 102 is reflected is displayed on the display unit 112.

In a region 1502 shown in FIG. 11A, there are displayed information about the total number of pages of the selected document data, a currently displayed page, and an output sheet size of the currently displayed page. In a region 1503, there are displayed information about operations that can be subsequently input by the user.

On the screen 2010 in FIG. 11B, three feature regions 2011 to 2013 defined in the print setting condition are displayed in this example. The feature regions 2011 to 2013 respectively represent a binding position (binding margin position), punch hole positions, and a page region.

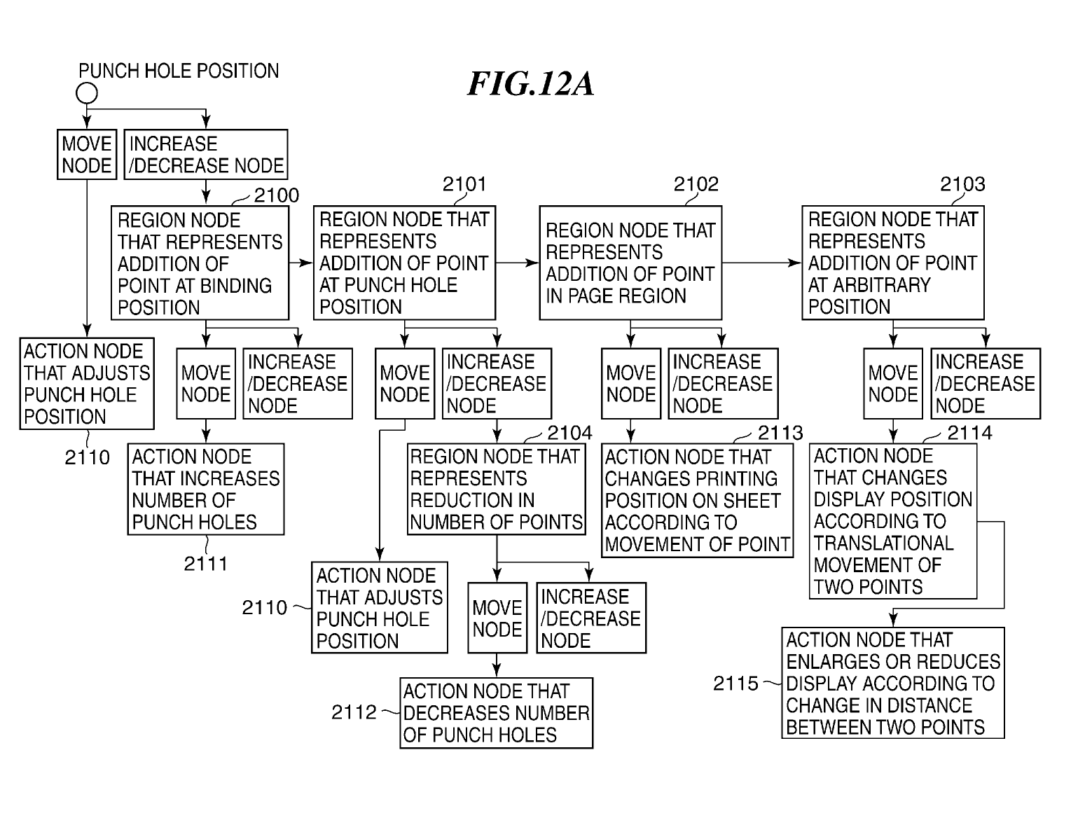

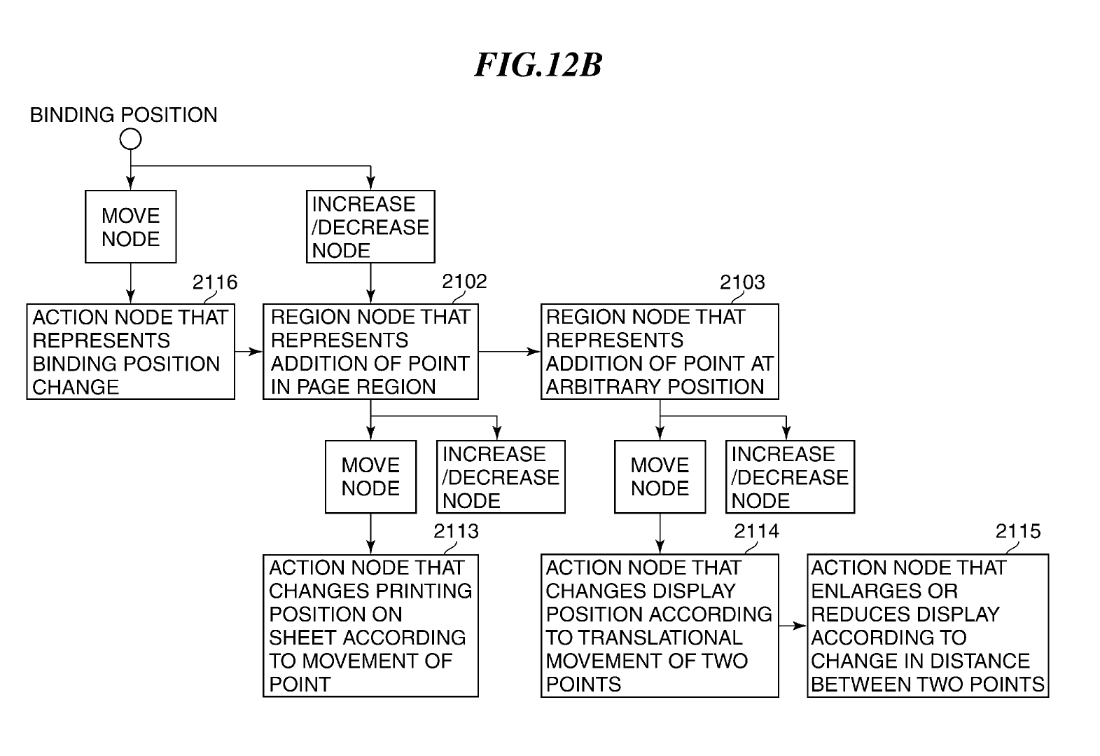

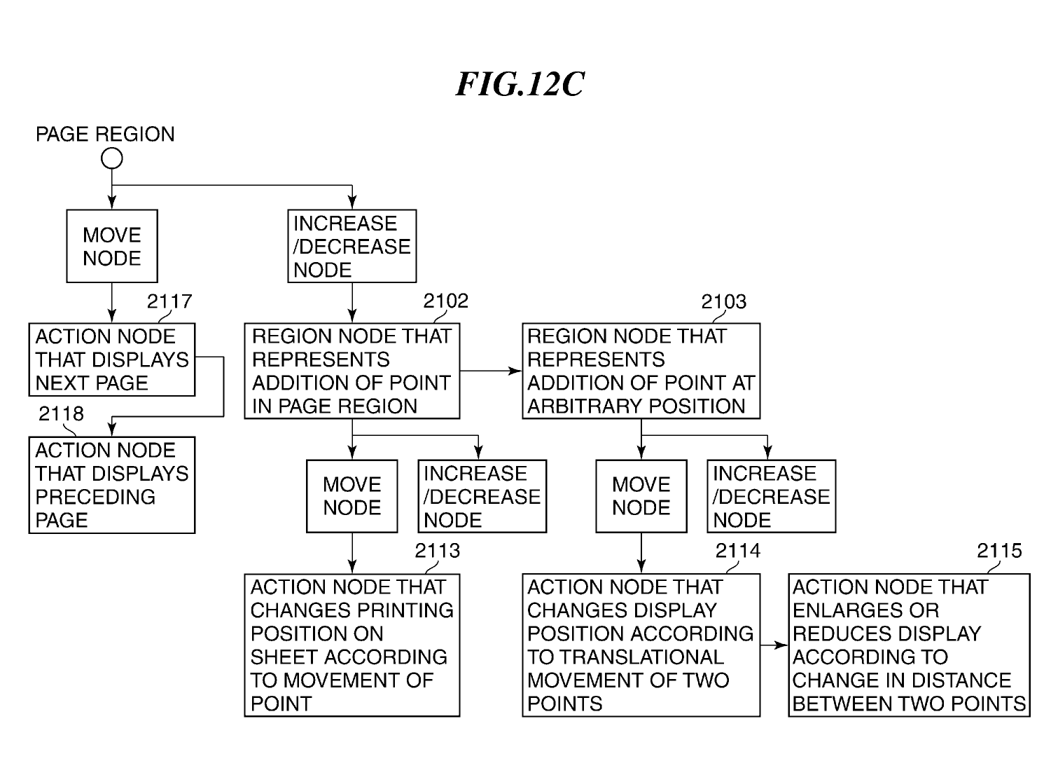

Sub input procedure trees respectively corresponding to the feature regions 2012, 2011, and 2013 are shown in FIGS. 12A to 12C. If it is determined that a position on the touch panel corresponding to the punch holes is pressed with a user's first finger, the control unit 116 performs a process according to the sub input procedure tree shown in FIG. 12A. If the pressed position corresponds to the binding position (other than punch hole positions), the control unit 116 performs a process according to the sub input procedure tree shown in FIG. 12B. If the pressed position corresponds to the page region (other than the binding position), the control unit 116 performs a process according to the sub input procedure tree shown in FIG. 12C.

When the binding position is pressed with the user's second finger while the touch panel is being pressed with the user's first finger, nodes 2100 and 2111 are used. When the touch panel is pressed with the user's second finger while at least one of the punch hole positions is being pressed with the user's first finger, nodes 2101, 2104, 2110 and 2112 are used. When the page region is pressed with the user's second finger while at least one of the punch hole positions is being pressed with the user's first finger, nodes 2102 and 2113 are used. When a position not corresponding to the nodes 2100 to 2102 is pressed with the user's second finger while the punch panel is being pressed with the user's first finger, nodes 2103, 2114 and 2115 are used. The following is a description of each node of the sub input procedure trees. In FIGS. 12A to 12C, the same nodes are denoted by the same reference numerals.

Reference numerals 2100 to 2102 denote region nodes each representing that an initial coordinate of a monitoring object point added in the top node or in an increase/decrease node corresponds to the feature region 2011, 2012 or 2013. Reference numeral 2103 denotes a region node representing that an initial coordinate of a point added in the top node or in an increase/decrease node is at an arbitrary position. Since the region node 2103 is connected to the last end of one or more preceding region nodes, the second print setting unit 118 performs a process specified in the region node 2103, only when received information does not meet one or more conditions specified in the one or more preceding region nodes.

Reference numeral 2104 denotes a region node represents that the number of monitoring object points decreases by one, i.e., represents that the number of points notified to the second print setting unit 118 decreases.

Reference numeral 2110 denotes an action node that adjusts a position of a punch hole to be formed in a printed output sheet (or in a non-printed output sheet) by a punching unit according to a movement of the monitoring object point concerned.

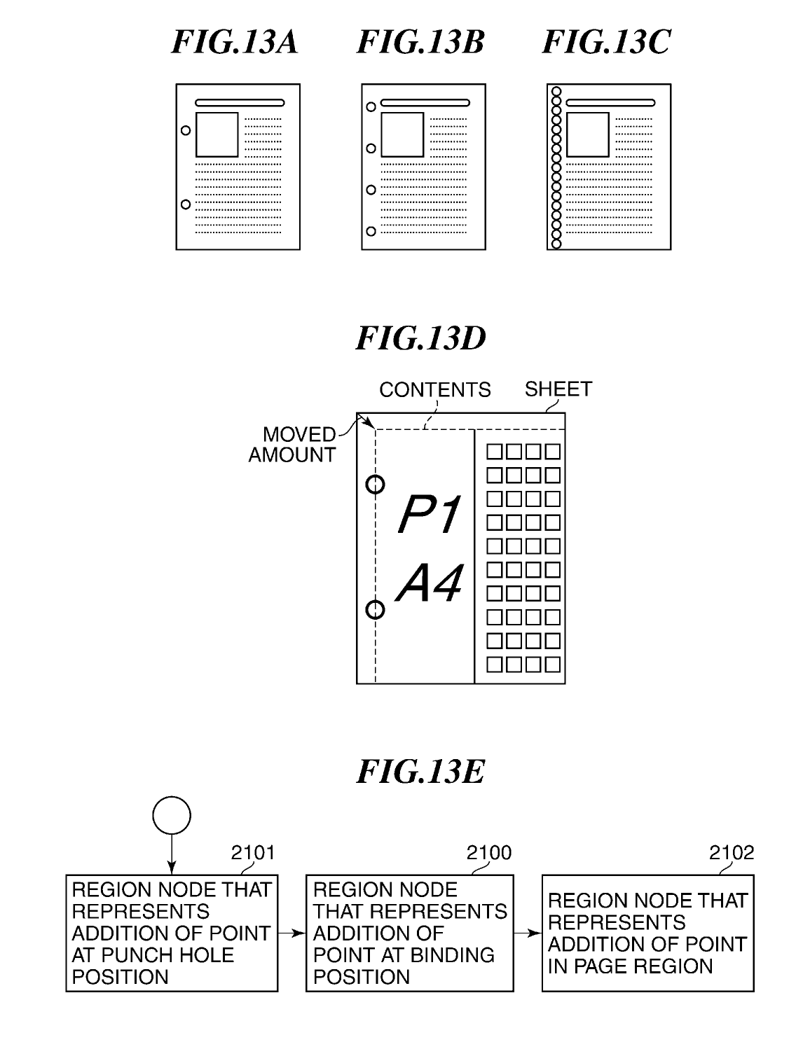

Reference numeral 2111 denotes an action node that increases the number of punch holes to be formed in an output sheet. In a case, for example, that there are three types of punch holes (shown in FIGS. 13A to 13C) that can be formed by the punching unit, the number of punch holes is increased to four or sixteen or the like, if a current setting requires that two holes or four holes or the like should be formed. If the current setting requires that sixteen holes should be formed, nothing is done in the action node 2111. When two positions in punch hole regions on the touch panel are pressed by the user with fingers and then the two pressed positions move, the second print setting unit 118 increases the number of punch holes. The movements of the two pressed positions can be made with a distance therebetween kept unchanged or varied.

Reference numeral 2112 denotes an action node that decreases the number of punch holes to be formed in an output sheet. In a case, for example, that there are three types of punch holes (shown in FIGS. 13A to 13C) that can be formed in an output sheet, the number of punch holes is decreased to four or two, if the current setting requires that sixteen holes or four holes should be formed. If the current setting requires that two holes (the lowest number of holes) should be formed, nothing is done in the action node 2112.

Reference numeral 2113 denotes an action node where the image processing apparatus 110 analyzes document data, creates image data (contents) to be printed on an output sheet, and prints the created image data on the output sheet. In the action node 2113, a printing position of the created image data on the output sheet is adjusted according to a movement of the monitoring object point concerned.

FIG. 13D schematically shows an image displayed in the region 2001 shown in FIG. 11A after the printing position is changed by the action node 2113.

Reference numeral 2114 denotes an action node that adjusts a display position of image data in the region 2001 in FIG. 11A according to movements of two monitoring object points.

When determining that a distance between coordinates represented by two pieces of coordinate information instructed by a user's gesture operation and received from the input unit 115 remains unchanged, the second print setting unit 118 performs processing defined in the action node 2114 and does not change the print settings.

Reference numeral 2115 denotes an action node that adjusts the magnitude of image data displayed in the region 2001 in FIG. 11A according to a change in the distance between two monitoring object points. When determining that the distance between coordinates represented by two pieces of coordinate information received from the input unit 115 changes, the second print setting unit 118 performs processing defined in the action node 2115 and does not edit the print settings.

Reference numeral 2116 denotes an action node performed by the first print setting unit 102 to change the binding position setting. The second print setting unit 118 moves the binding position according to information input from the input unit 115.

In FIG. 12C, reference numeral 2117 denotes an action node that displays the next page, if the displayed document data is constituted by plural pages. In the action node 2117, the second print setting unit 118 does not edit the print settings.

Reference numeral 2118 denotes an action node that displays the preceding page, if the displayed document data is constituted by plural pages. In the action node 2118, the second print setting unit 118 does not edit the print settings. The control unit 116 decides which of the nodes 2117 and 2118 should be used according to a moving direction of an instruction position input by the user.

FIG. 13E shows an input procedure tree obtained by combining the above-described sub input procedure trees. To combine the sub input procedure trees, the second print setting unit 118 couples the top node of the sub input procedure tree having the smallest feature region to the top node of the input procedure tree, couples the sub input procedure tree having the next smallest feature region to the sub input procedure tree coupled to the top node of the input procedure tree, and similarly couples the other sub input procedure trees in sequence.

Next, the second print setting unit 118 corrects the input procedure tree. In the case of the input procedure tree shown in FIG. 13E, there are four types of editing of the print settings that can be performed by the second print setting unit 118, i.e., changing the number of punch holes, adjusting punch hole positions, changing the binding position, and adjusting the printing position.

It is determined by the control unit 116 that the punch hole positions cannot be adjusted by the post-processing unit 121, the second print setting unit 118 deletes one or more action nodes for adjusting punch hole positions from the input procedure tree.

In FIG. 11A, screen 2000 is shown, which is displayed when the second print setting unit 118 does not receive information from the input unit 115. Accordingly, in the region 1503 in FIG. 11A, information (message) is displayed that prompts to input a coordinate of a region coupled to the top node of the input procedure tree.

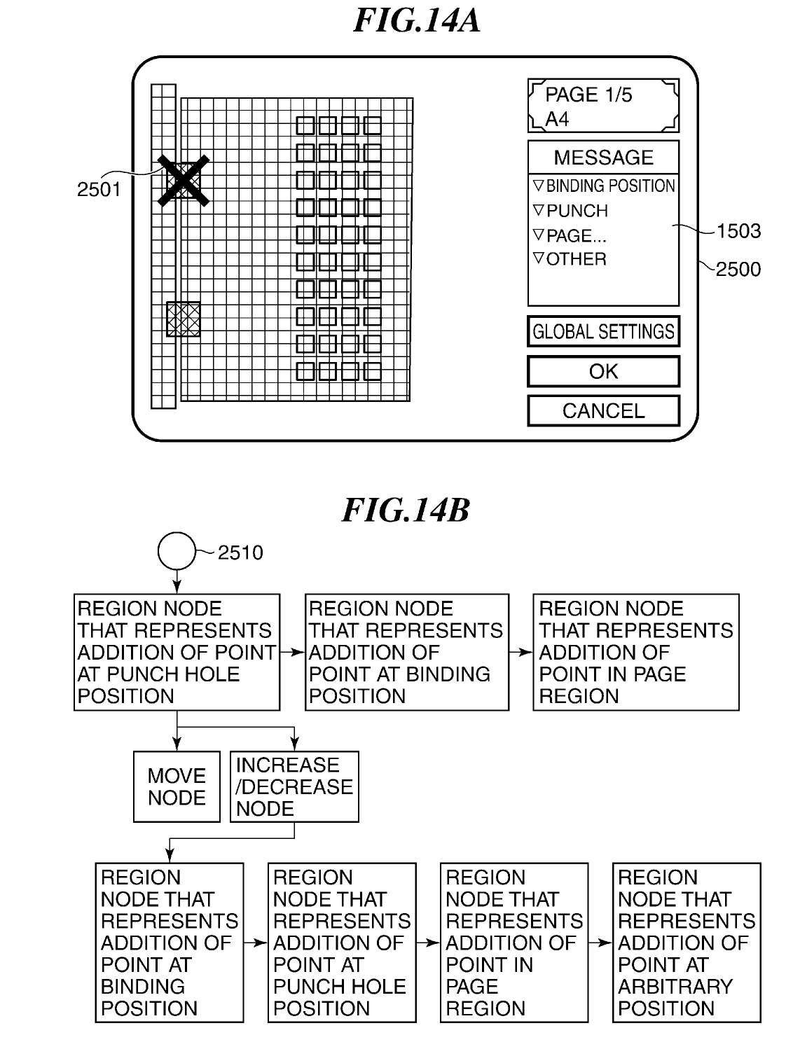

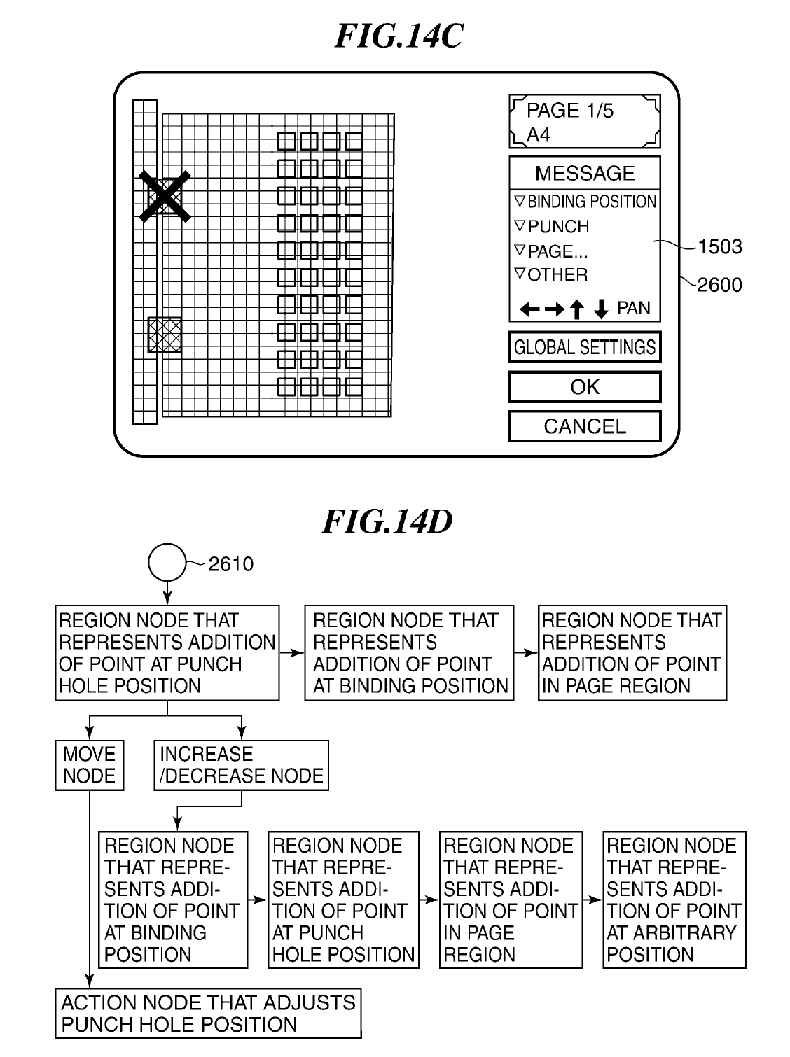

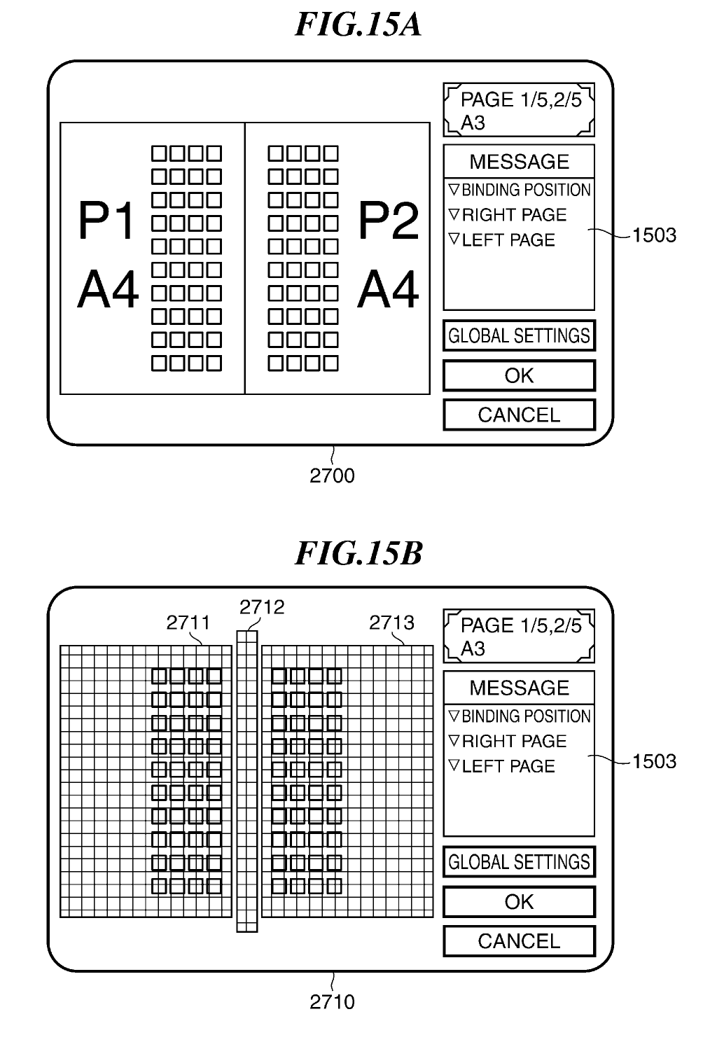

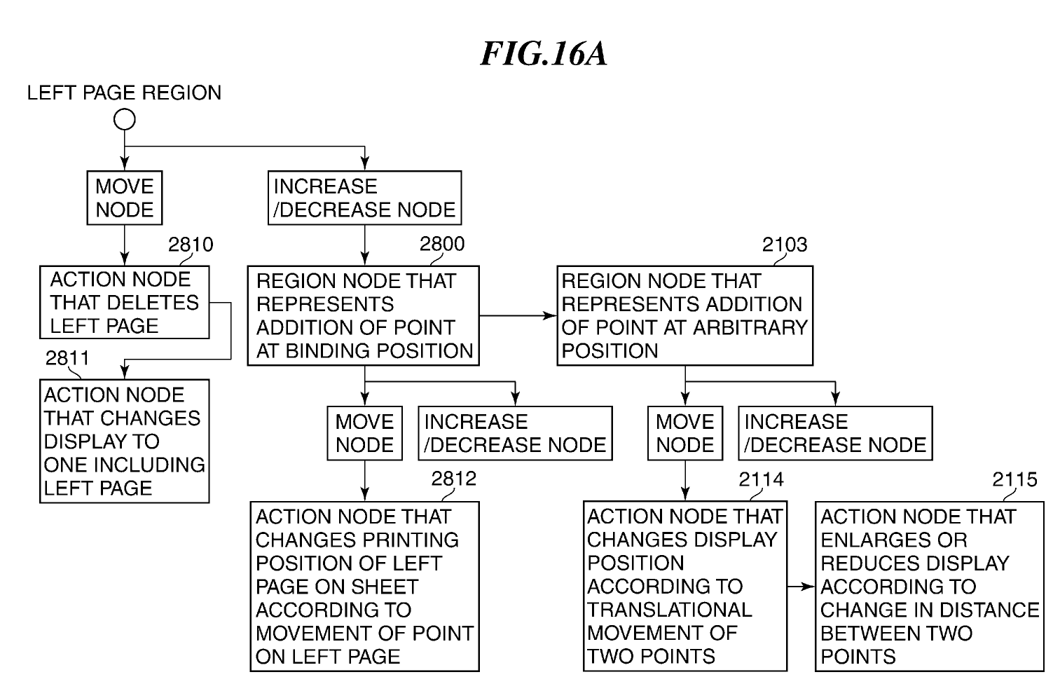

When coordinate information representing a punch hole position instructed by a user's gesture operation is notified from the input unit 115, the screen 2010 shown in FIG. 11A is changed over to a screen 2500 shown in FIG. 14A.

In FIG. 14A, a feature region 2501 represents a coordinate instructed by a user's gesture operation through the input unit 115. This indicates that the second print setting unit 118 has received an input for a region node associated with a punch hole position and coupled to the top node of the input procedure tree created according to the print settings for the print job.

In FIG. 14B, there is shown a sub input procedure tree 2510 corresponding to the screen display show in FIG. 14A. According to the sub input procedure tree 2510, instructions input by a user's gesture operation that can be accepted by the second print setting unit 118 are those relating to binding position, punch hole position, page region, and increase in the number of monitoring object points in some other region. Accordingly, in the region 1503 shown in FIG. 14A, pieces of information prompting to input a binding position, punch hole position, page region, and coordinate of some other region are displayed in this order.

In FIG. 14D, there is shown an input procedure tree 2610 for a case where the punching unit can adjust the punch hole position. In the region 1503 on the screen 2600 shown in FIG. 14C, information prompting to move an monitoring object point associated with a punch hole position adjustment is displayed.

Next, a description will be given of an example action of the second print setting unit 118 in a case that the print setting condition specifies that bookbinding should be performed as post processing.

FIGS. 15A and 15B each show an example print setting operation screen displayed on the display unit 112 of the image processing apparatus 110. In these examples, if bookbinding has been set as post processing, the second print setting unit 118 causes the display unit 112 to display a screen 2700 or 2710.

As shown in the screen 2710, the second print setting unit 118 defines three feature regions 2711 to 2713 respectively representing a left page region, binding position, and right page region.

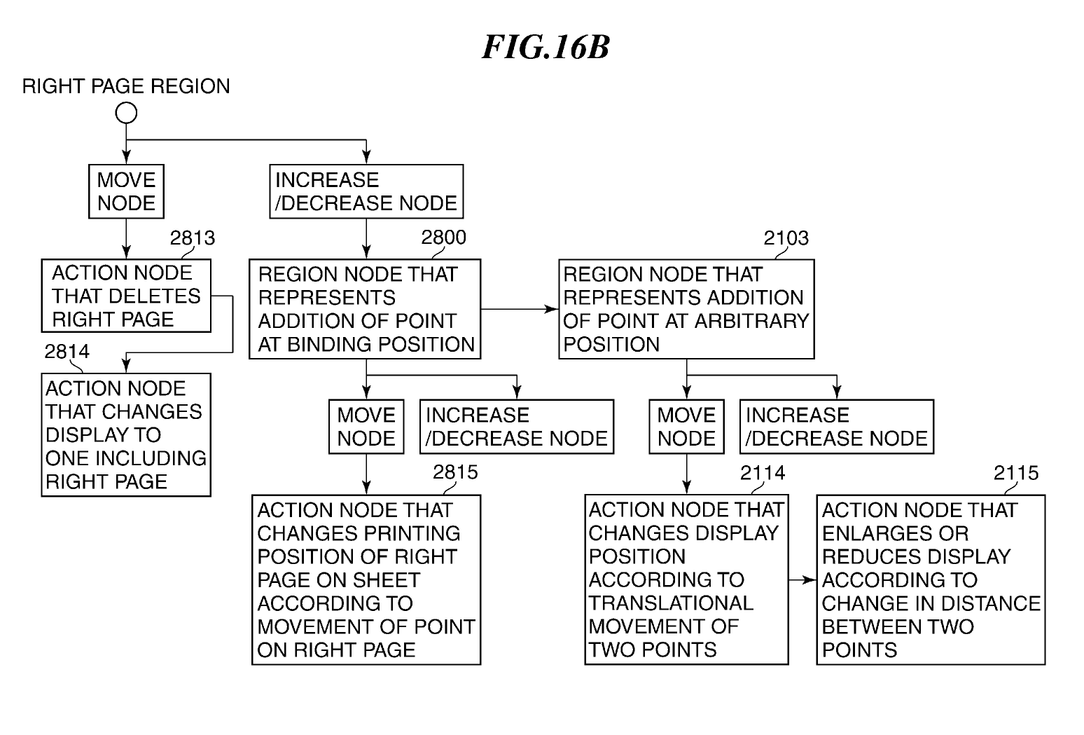

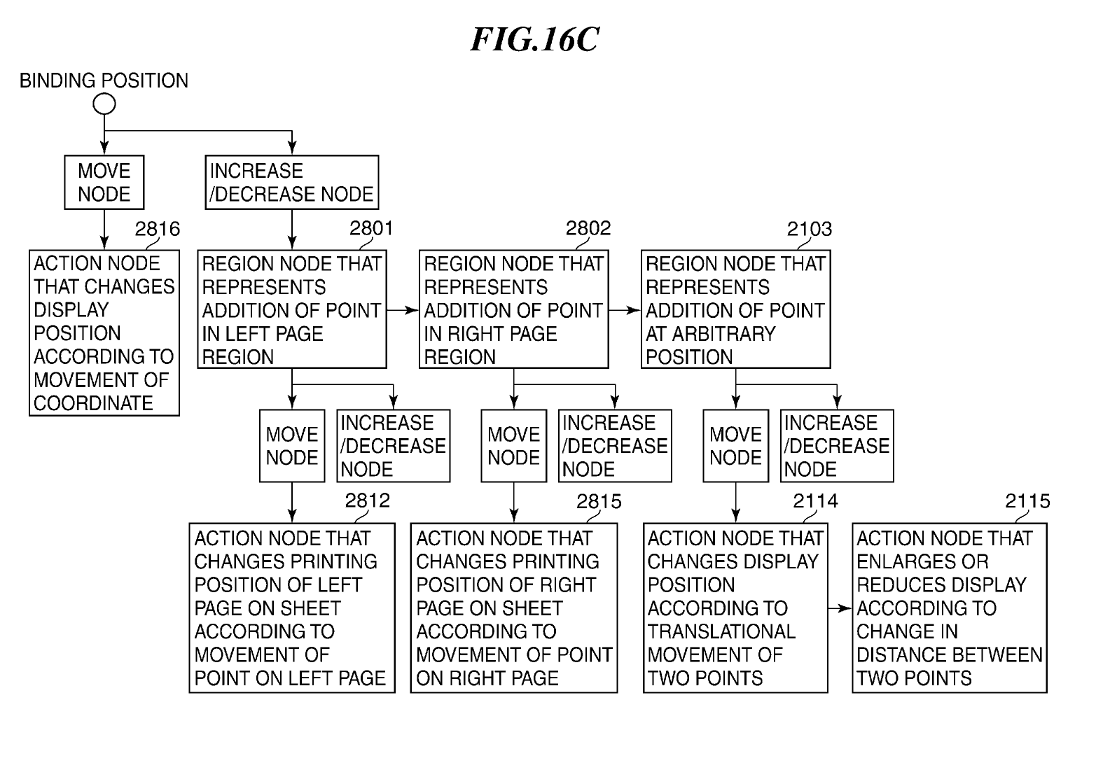

FIGS. 16A to 16C show sub input procedure trees respectively corresponding to the feature regions 2711, 2713, and 2712 in the print setting screen 2710 in FIG. 15B.

In FIGS. 16A to 16C, nodes whose functions are substantially the same as those of the above-described nodes are denoted by the same reference numerals.

In FIGS. 16A to 16C, reference numerals 2800 to 2802 denote region nodes each representing that an initial coordinate of a monitoring object point added in the top node or in an increase/decrease node is within a region corresponding to the feature region 2711 or 2712 or 2713. In other words, nodes to be used are decided according to which of the regions is pressed by the user's second finger while the touch panel is being pressed with the user's first finger.

Reference numeral 2810 denotes an action node that removes from print objects a left page among currently displayed left and right pages when the monitoring object point concerned moves leftward. For example, when processing defined in the action node 2810 is executed in a state that the second and third pages of document data of six pages are displayed, the second print setting unit 118 edits the print settings such that bookbinding will be performed, while removing the second page of the document data.

Reference numeral 2811 denotes an action node that changes the display in the region 1501 in FIG. 6B over to double-spread display, which includes as left page a page of image data currently displayed in the region 1501 when the monitoring object point moves rightward. The second print setting unit 118 does not edit the print settings.

Reference numeral 2812 denotes an action node that adjusts, like the action node 2113 in FIG. 12A, a printing position of the left page of currently displayed image data on an output sheet according to a movement of the monitoring object point. In the booklet printing of this embodiment, printing positions of left and right pages of image data can be edited independently of each other.

Reference numeral 2813 denotes an action node that removes from print objects a right page among currently displayed left and right pages when the monitoring object point moves rightward. For example, when processing defined in the action node 2813 is executed in a state that the second and third pages of document data of six pages are displayed, the second print setting unit 118 edits the print settings such that bookbinding will be performed, while removing the third page of the document data.

Reference numeral 2814 denotes an action node that changes the display in the region 1501 in FIG. 6B over to double-spread display, which includes as right page a page of image data currently displayed in the region 1501 when the monitoring object point moves leftward. The second print setting unit 118 does not edit the print settings.

Reference numeral 2815 denotes an action node that adjusts a printing position of the right page of currently displayed image data on an output sheet according to a movement of the monitoring object point. In the booklet printing of this embodiment, printing positions of left and right pages of image data can be edited independently of each other.

Reference numeral 2816 denotes an action node that adjusts, like the action node 2114 in FIG. 12A, a position at which image data is displayed in the region 2001 in FIG. 6B according to a movement of the monitoring object point. The action node 2816 differs from the action node 2114 in the number of monitoring object points. The second print setting unit 118 combines the sub input procedure trees to thereby create an input procedure tree.

Next, a description will be given of an example action of the second print setting unit 118 in a case that Z folding (folding on one side) has been set in the print setting condition.

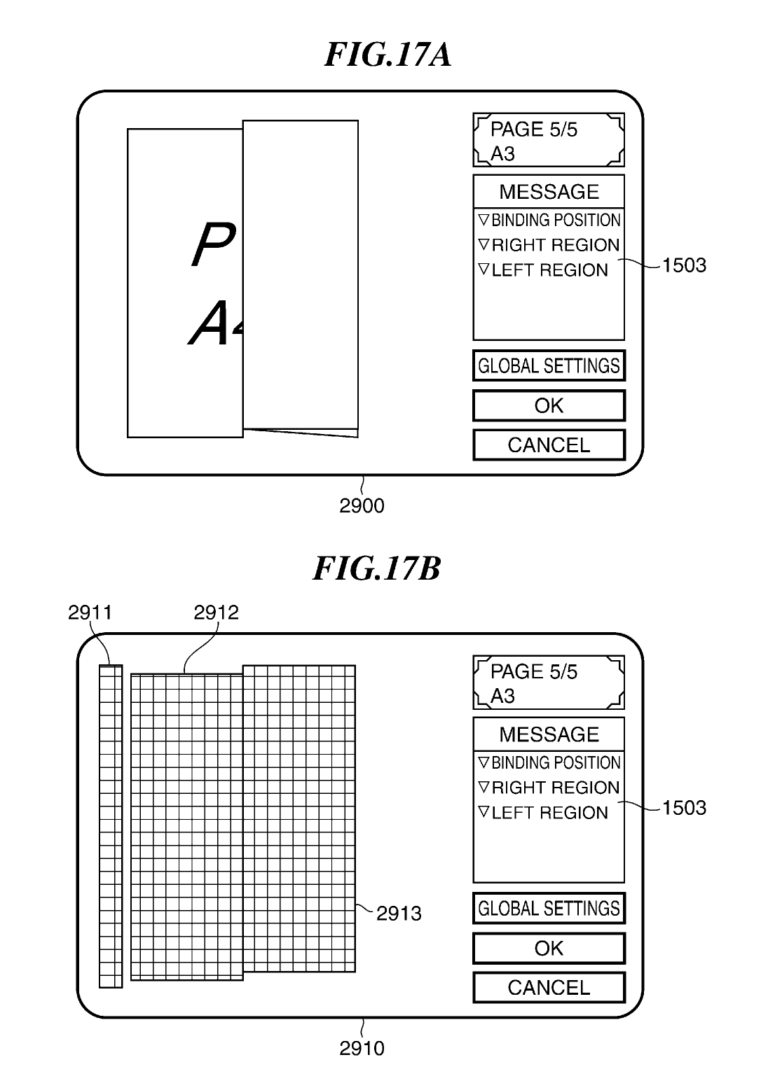

FIGS. 17A and 17B each show an example print setting operation screen displayed on the display unit 112 of the image processing apparatus 110. In these examples, the second print setting unit 118 causes the display unit 112 to display a screen 2900 or 2910, if Z folding (folding on one side) has been set.

As shown in the screen 2910 in FIG. 17B, the second print setting unit 118 defines three feature regions, i.e., a binding position 2911, left region 2912, and right region 2913.

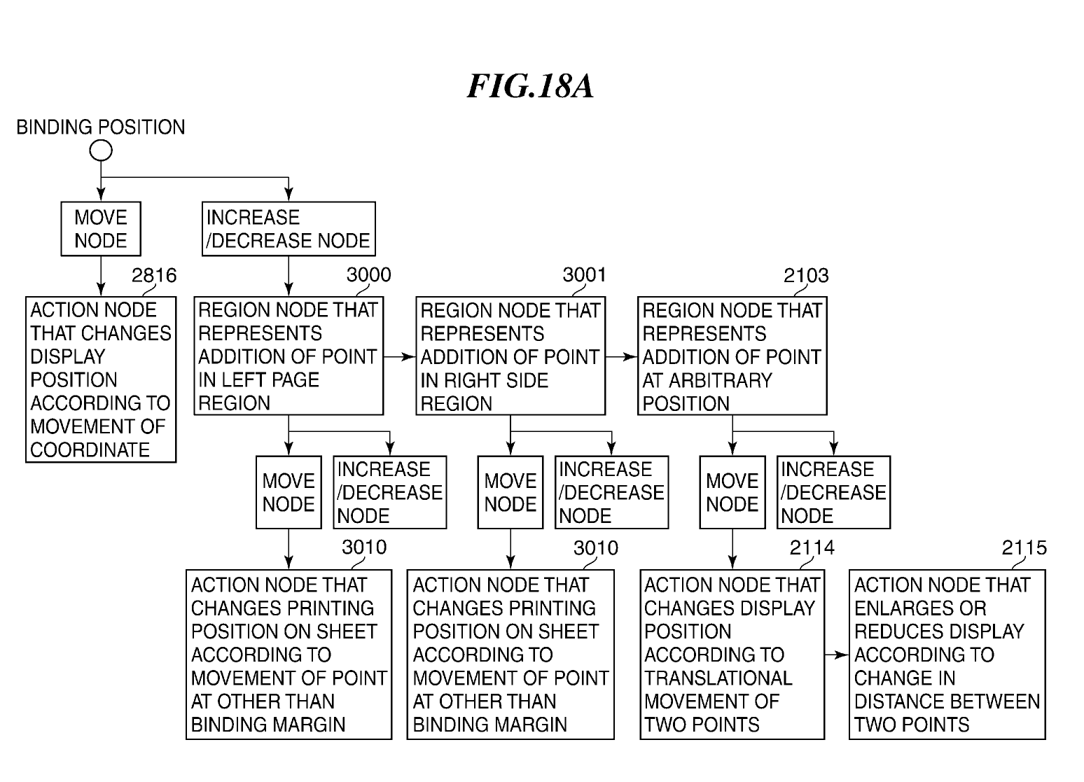

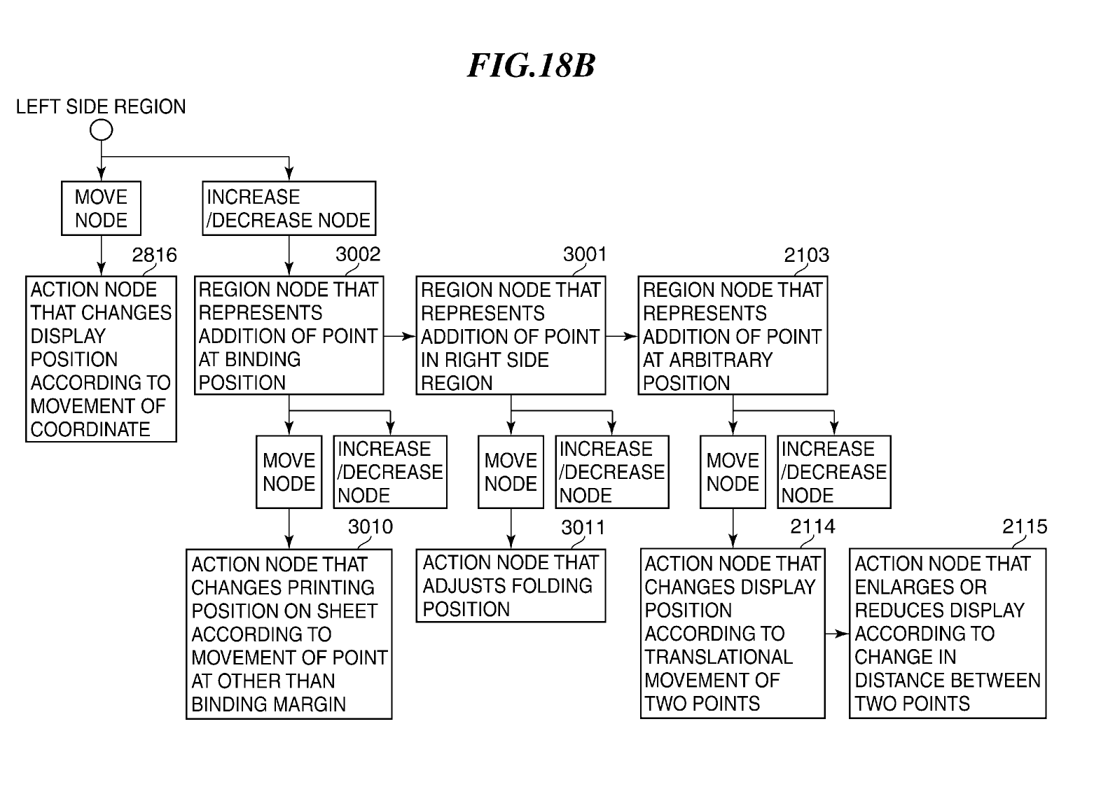

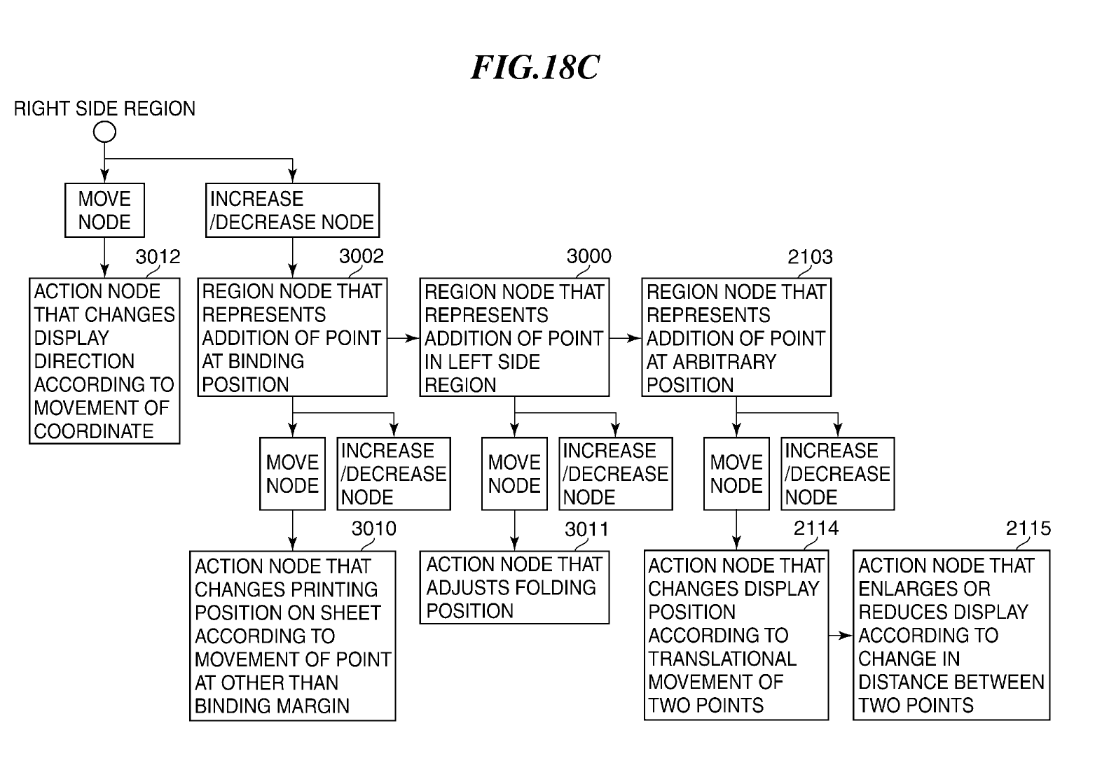

FIGS. 18A to 18C show sub input procedure trees respectively corresponding to the feature regions 2911 to 2913 in the print setting screen 2910 in FIG. 17B.

In FIGS. 18A to 18C, nodes whose functions are substantially the same as those of the above-described nodes are denoted by the same reference numerals.

In FIGS. 18A to 18C, reference numerals 3000 to 3002 denote region nodes each representing that an initial coordinate of a monitoring object point added in the top node or in an increase/decrease node is within a region corresponding to the binding position 2911 or left region 2912 or right region 2913.

Reference numeral 3010 denotes an action node that adjusts a printing position of currently displayed image data on an output sheet according to a movement of the monitoring object point concerned whose initial coordinate is within the left region 2912 or within the right region 2913.

Reference numeral 3011 denotes an action node that adjusts a position where the output sheet is folded by a folding unit.

In FIG. 18C, reference numeral 3012 denotes an action node that performs a changeover between a state where an image is displayed in a double-spread form and a state where the image is displayed in a folded form on the screen 2900 in FIG. 17A or on the screen 2910 in FIG. 17B according to a movement of the monitoring object point.

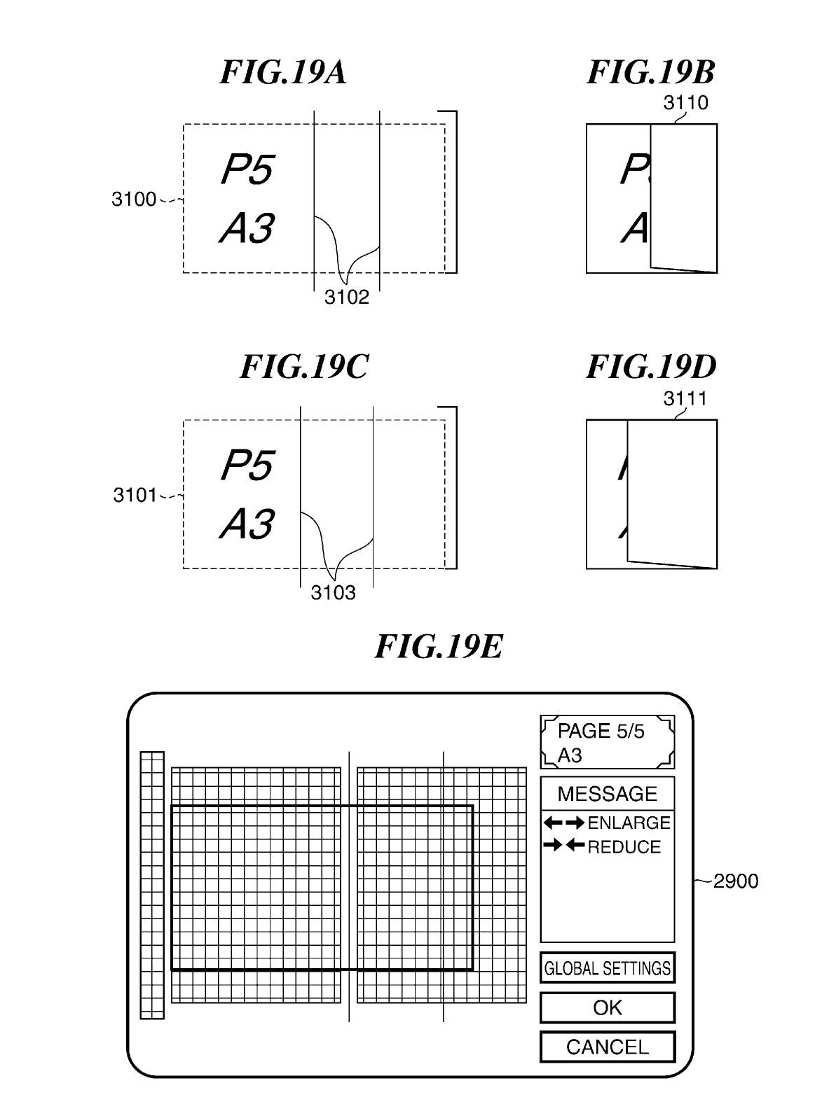

FIGS. 19A to 19E show an example of print setting operations for the image processing apparatus 110. In this example, a case is described, in which a setting of output sheet folding positions is changed.

In FIGS. 19A and 19C, reference numerals 3100 and 3101 each denote an output sheet (contents) in a developed state. Reference numeral 3102 denotes lines that represent output sheet folding positions before the fold position setting is changed, and 3103 denotes lines that represent output sheet folding positions after change of the fold position setting.

In FIGS. 19B and 19D, reference numeral 3110 denotes a state where the output sheet is folded along the lines 3102 by a folding unit, and 3111 denotes a state where the output sheet is folded along the lines 3103 by the folding unit.

On the screen 2900 in FIG. 17A, an output sheet image is displayed is in a folded state. On the screen 2900 in FIG. 19E, an output sheet image is displayed in a double-spread form.

With regard to print settings (e.g., settings of binding position and the number of punch holes among the print settings edited as described above) which are invalid if they are set separately only for some pages of document data, the second print setting unit 118 directly changes the print settings 1200 in FIG. 5.

On the other hand, with regard to print settings (e.g., settings of printing position adjustment and folding position adjustment) which are valid even if they are set separately only for some pages of document data, the second print setting unit 118 adds exceptional print settings to print data.

It should be noted that the feature regions can be displayed in an image displayed in the region 1501 in FIG. 6B on the display unit 112 by the second print setting unit 118. In that case, the user is able to more accurately operate the input unit 115 according to the image displayed in the region 1501 and the information displayed in the region 1503.

As described above, since the input unit 115 is able to simultaneously notify a plurality of positions instructed by a user's gesture to the second print setting unit 118, the user can intuitionally operate the input unit 115.

Since the input unit 115 is capable of inputting a large quantity of information corresponding to the power of the number of points in a coordinate range that can be detected by the input unit 115, the second print setting unit 118 is able to define various operation methods.

The second print setting unit 118 defines region information and sub input procedure trees on a per print setting basis and edits the print settings according to the defined information and procedure trees. As a result, it is possible to flexibly define operations that can be intuitionally performed by the user and to flexibly handle a variety of print settings.

Since the region information can be defined on a per output sheet basis, the region information can be adapted to document data for which various output sheets are specified.

### Second Embodiment

In the first embodiment, a case has been described in which the second print setting unit 118 of the image processing apparatus 110 defines region information and sub input procedure trees. Alternatively, region information and sub input procedure trees can be created by a setting unit other than the second print setting unit 118 and can be held in the storage unit 111 to be able to be referred to by the setting unit 118. This enables the second print setting unit 118 to edit print settings based on region information and sub input procedure trees. In the following, a description is given of a second embodiment of this invention configured to that end.

When the post-processing apparatus 120 is connected to the image processing apparatus 110, the first print setting unit 102 of the host computer 100 creates region information and sub input procedure trees relating to print settings including a setting of post processing that can be performed by the post-processing apparatus 120 and transfers them to the storage unit 111 of the image processing apparatus 110, whereby the second print setting unit 118 of the image processing apparatus 110 can become able to edit the print settings including the setting of post processing.

### Third Embodiment

The second print setting unit 118 can be configured not only to cooperate with the control unit 116 to delete from an input procedure tree an action node that cannot be edited, but also to cause, according to information input from the control unit 116, the display unit 112 to display a region that can be input through the input unit 115. In the following, a third embodiment of this invention configured to that end will be described.

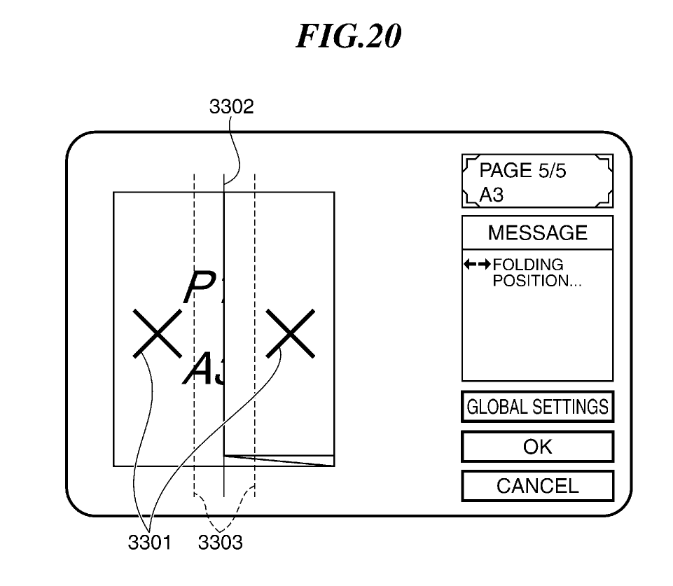

In a case, for example, that positions where an output sheet is folded in the Z folding (folding on one side) are restricted by the control unit 116, the second print setting unit 118 causes the display unit 112 to display an image such as that shown in FIG. 20.

In FIG. 20, reference numeral 3301 denotes points instructed by a user's gesture operation entered through the input unit 115, 3302 denotes a line that represents an output sheet folding position, and 3303 denotes lines that represent a region within which the output sheet folding position can be changed.

As described above, the second print setting unit 118 causes, according to information input from the control unit 116, the display unit 112 to display a region for which a user's instruction can be input through the input unit 115, whereby it becomes easy for the user to understand a method for inputting an instruction into the input unit 115.

In the embodiments, examples have been described in which the setting of post processing set in advance by the host computer 100 is changed. However, it is possible to configure that a new setting can be set according to a gesture operation (input of an instruction position). For example, even if punching is not set in advance by the host computer 100, it is possible to configure that a punch hole is newly set when a touch panel region corresponding to a particular region of document data is pressed with fingers and then the fingers (instruction positions) move on the touch panel.

The setting performed by movements (motions) of instruction positions is not limited to the setting of a punch hole, but can be applied to settings relating to folding processing and bookbinding processing and to other setting.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-060842, filed Mar. 17, 2010, which is hereby incorporated by reference herein in its entirety.

What is claimed is:

1. An image processing apparatus that causes a post-processing apparatus to perform post processing on a sheet printed with image data, comprising:
a detection unit configured to detect motions of instruction positions input through a touch panel; and
a setting unit configured to perform setting of the post processing according to the motions of the instruction positions detected by said detection unit.

2. The image processing apparatus according to claim 1, further including:
a display unit configured to display a preview of contents of the setting of the post processing performed by said setting unit so as to be associated with the image data.

3. The image processing apparatus according to claim 1, wherein the setting of the post processing is changed according to the motions of the instruction positions detected by said detection unit.

4. The image processing apparatus according to claim 1, further including:
an acquisition unit configured to acquire ability information of the post-processing apparatus from the post-processing apparatus,
wherein said setting unit changes the setting of the post processing according to the motions of the instruction positions detected by said detection unit and the ability information acquired by said acquisition unit.

5. The image processing apparatus according to claim 1, wherein changing the setting of the post processing includes moving a position to be subjected to the post processing or increasing or decreasing number of positions to be subjected to the post processing.

6. The image processing apparatus according to claim 1, wherein the post processing includes punching processing or binding processing or folding processing.

7. A control method for an image processing apparatus that causes a post-processing apparatus to perform post processing on a sheet printed with image data, comprising:
detecting motions of instruction positions input through a touch panel; and
performing setting of the post processing according to the detected motions of the instruction positions.

8. A non-transitory computer-readable storage medium storing a program for causing a computer to execute the control method as set forth in claim 7.
